(19) United States
(12) Patent Application Publication
(10) Pub. No.: US 2008/0239086 A1
(43) Pub. Date: Oct. 2, 2008

(54) DIGITAL CAMERA, DIGITAL CAMERA CONTROL PROCESS, AND STORAGE MEDIUM STORING CONTROL PROGRAM

(75) Inventor: Mitsumi NAKAMURA, Saitama-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/020,007

(22) Filed: Jan. 25, 2008

(30) Foreign Application Priority Data
Mar. 28, 2007 (JP) 2007-085275

(51) Int. Cl. H04N 5/228

(52) U.S. Cl. 348/222.1; 348/E05.031

(57) ABSTRACT

A digital camera that includes an imaging component, a display component, a characteristic information extraction component, an assistance image determination component and a control component. The imaging component images a subject and outputs image information representing the subject. The display component implements display on the basis of the image information outputted from the imaging component. The characteristic information extraction component extracts characteristic information representing a pre-specified characteristic from the image information. The assistance image determination component determines an assistance image, for assisting a determination of composition when the subject is to be photographed, on the basis of a result of extraction by the characteristic information extraction component. The control component controls the display component such that the assistance image determined by the assistance image determination component is displayed superimposed with the subject that is being displayed by the display component.

### CROSS-REFERENCE TO RELATED APPLICATION

This application claims priority under 35 USC 119 from Japanese Patent Application No. 2007-085275, the disclosure of which is incorporated by reference herein.

### BACKGROUND OF THE INVENTION

1. Field of the Invention

The present invention relates to a digital camera, a digital camera control process and a storage medium storing a control program, which include a function that assists a determination of composition when photographing a subject.

2. Description of the Related Art

Digital cameras are known which display an assistance image, at a display component such as a liquid crystal viewfinder or the like, in order to assist a determination of composition when photographing a subject.

In this kind of digital camera, a plurality of types of assistance image are prepared beforehand. At a time of photography, a photographer selects one from the plurality of types of assistance image, and that assistance image is displayed at the display component. Alternatively, a pre-specified assistance image is automatically displayed at the display component. (See, for example, Japanese Patent Application Laid-Open (JP-A) Nos. 2002-131824, 2000-270242, 2006-222690, 2006-74368, 2001-211362 and 2007-13768.)

However, with the digital camera described above, there is a problem in that a suitable assistance image corresponding to a subject will not necessarily be displayed at the display component. Moreover, selecting one from the plurality of types of assistance image that have been prepared beforehand takes time for the photographer, and consequently a likelihood of missing a shooting chance is high, which is a problem.

### SUMMARY OF THE INVENTION

The present invention has been devised in order to solve the problems described above, and an object of the present invention is to provide a digital camera, a digital camera control process and a storage medium storing a control program that are capable of causing an assistance image that corresponds to a subject to be easily displayed.

A digital camera of a first aspect of the present invention includes: an imaging component that images a subject and outputs image information representing the subject; a display component that implements display on the basis of the image information outputted from the imaging component; a characteristic information extraction component that extracts characteristic information representing a pre-specified characteristic from the image information; an assistance image determination component that determines an assistance image, for assisting a determination of composition when photographing the subject, on the basis of a result of extraction by the characteristic information extraction component; and a control component that controls the display component such that the assistance image determined by the assistance image determination component is displayed superimposed with the subject that is being displayed by the display component.

A digital camera control process of a second aspect of the present invention includes: an imaging step of imaging a subject and outputting image information representing the subject; a display step of implementing display on the basis of the image information; a characteristic information extraction step of extracting characteristic information representing a pre-specified characteristic from the image information; an assistance image determination step of determining an assistance image, for assisting a determination of composition when photographing the subject, on the basis of a result of the extraction in the characteristic information extraction step; and a control step of implementing control such that the assistance image determined by the assistance image determination step is displayed superimposed with the subject displayed by the display step.

A control program stored at a storage medium of a third aspect of the present invention includes: an imaging step of outputting image information representing a subject which has been imaged; a step of controlling a display component so as to implement display on the basis of the image information; a characteristic information extraction step of extracting characteristic information representing a pre-specified characteristic from the image information; an assistance image determination step of determining an assistance image, for assisting a determination of composition when photographing the subject, on the basis of a result of the extraction in the characteristic information extraction step; and a control step of implementing control such that the assistance image determined by the assistance image determination step is displayed superimposed with the subject that is being displayed at the display component.

### BRIEF DESCRIPTION OF THE DRAWINGS

FIG. 1 is an exterior view showing the exterior of a digital camera relating to first to third embodiments of the present invention.

FIG. 2 is a block diagram showing structure of principal elements of an electronic system of the digital camera relating to the first to third embodiments of the present invention.

FIG. 3 is a schematic diagram showing structure of an image file relating to an embodiment of the present invention.

FIG. 4 is a flowchart showing a flow of processing of a display control processing program relating to the first embodiment of the present invention.

FIG. 5A to FIG. 5F are front views showing states of through-images that are displayed at an LCD relating to the first embodiment of the present invention.

FIG. 6A to FIG. 6F are front views showing states of assistance images that are displayed at the LCD relating to the first embodiment of the present invention.

FIG. 7A to FIG. 7F are front views showing display states at the LCD consequent to execution of the display control processing program relating to the first embodiment of the present invention.

FIG. 8 is a flowchart showing a flow of processing of a display control processing program relating to the second embodiment of the present invention.

FIG. 9A is a front view showing a state of a through-image that is displayed at an LCD by execution of a display control processing program relating to the second embodiment of the present invention.

FIG. 9B is a front view showing a state of an assistance image that is displayed at the LCD by execution of the display control processing program relating to the second embodiment of the present invention.

FIG. 9C is a front view showing a state when the through-image shown in FIG. 9A is displayed superimposed with the assistance image shown in FIG. 9B by execution of the display control processing program relating to the second embodiment of the present invention.

FIG. 10A is a front view showing a state of a through-image that is displayed at the LCD by execution of the display control processing program relating to the second embodiment of the present invention.

FIG. 10B is a front view showing a state of an assistance image that is displayed at the LCD by execution of the display control processing program relating to the second embodiment of the present invention.

FIG. 10C is a front view showing a state when the through-image shown in FIG. 10A is displayed superimposed with the assistance image shown in FIG. 10B by execution of the display control processing program relating to the second embodiment of the present invention.

FIG. 11A is a front view showing a state of a through-image that is displayed at the LCD by execution of the display control processing program relating to the second embodiment of the present invention.

FIG. 11B is a front view showing a state of an assistance image that is displayed at the LCD by execution of the display control processing program relating to the second embodiment of the present invention.

FIG. 11C is a front view showing a state when the through-image shown in FIG. 11A is displayed superimposed with the assistance image shown in FIG. 11B by execution of the display control processing program relating to the second embodiment of the present invention.

FIG. 12 is a flowchart showing a flow of processing of a display control processing program relating to the third embodiment of the present invention.

FIG. 13A to FIG. 13C are front views showing display states at an LCD consequent to execution of the display control processing program relating to the third embodiment of the present invention.

FIG. 14 is a block diagram showing structure of principal elements of an electronic system of the digital camera relating to fourth to sixth embodiments of the present invention.

FIG. 15A and FIG. 15B are a flowchart showing a flow of processing of a display control processing program relating to the fourth embodiment of the present invention.

FIG. 16 is a view showing 25 intersections at which five straight lines that horizontally divide a screen of an LCD relating to the fourth embodiment of the present embodiment into equal sixths and five straight lines that vertically divide the screen of the LCD into equal sixths intersect.

FIG. 17 is a view for describing a position, on the screen of the LCD relating to the fourth embodiment of the present invention, at which a face photography assistance image is displayed.

FIG. 18 is a front view showing a state in which a general assistance image and the face photography assistance image are displayed superimposed with a through-image on the screen of the LCD relating to the fourth embodiment of the present invention.

FIG. 19 is a front view showing a different case from FIG. 18 of a state in which the general assistance image and face photography assistance images are displayed superimposed with a through-image on the screen of the LCD relating to the fourth embodiment of the present invention.

FIG. 20A and FIG. 20B are a flowchart showing a flow of processing of a display control processing program relating to the fifth embodiment of the present invention.

FIG. 21 is a front view showing a state in which a general assistance image and a face photography assistance image are displayed superimposed with a through-image on a screen of an LCD relating to the fifth embodiment of the present invention.

FIG. 22A and FIG. 22B are a flowchart showing a flow of processing of a display control processing program relating to the sixth embodiment of the present invention.

FIG. 23A and FIG. 23B are front views showing states, at a screen of an LCD relating to the sixth embodiment of the present invention, when people are photographed in a state in which a digital camera is fixed such that a direction of pressing operation of a release switch is along a vertical direction.

FIG. 24A and FIG. 24B are front views showing states, at the screen of the LCD relating to the sixth embodiment of the present invention, when people are photographed in a state in which the digital camera is fixed such that the direction of pressing operation of the release switch is along a horizontal direction.

FIG. 25 is a view showing the state in which the digital camera is fixed such that the direction of pressing operation of the release switch is along the horizontal direction.

FIG. 26 is a view showing a different case from FIG. 25 of the state in which the digital camera is fixed such that the direction of pressing operation of the release switch is along the horizontal direction.

### DETAILED DESCRIPTION OF THE INVENTION

Below, a best mode for implementing the present invention will be described in detail with reference to the drawings. In the embodiments described below, cases will be described of application of the present invention to a digital electronic still camera which performs photography of still images (hereafter referred to as a digital camera).

### FIRST EMBODIMENT

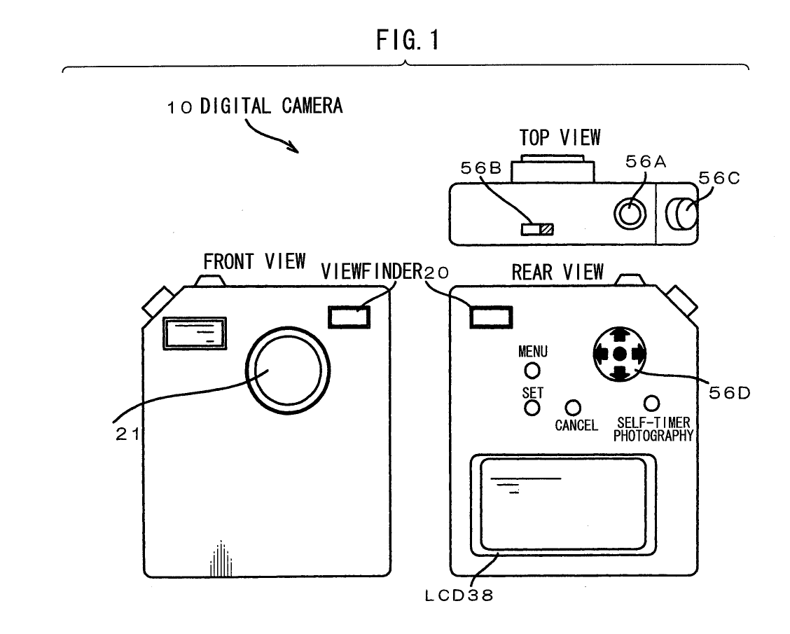

Firstly, structure of the exterior of a digital camera 10 relating to the present embodiment will be described with reference to FIG. 1.

As is shown in FIG. 1, a lens 21, for focusing an image, and a viewfinder 20, which is used for determinations of composition of subjects to be photographed, are provided at a front face of the digital camera 10. A release button (a “shutter button”) 56A, which is pressed for operation when photography is to be executed, a power switch 56B and a mode-switching switch 56C are provided at an upper face of the digital camera 10.

The release button 56A of the digital camera 10 relating to the present embodiment is pressed for operation along a vertical direction and is structured to be capable of sensing two stages of a pressing operation—a state of being pressed to an intermediate position (below referred to as a half-pressed state) and a state of being pressed beyond the intermediate position to a bottommost position (below referred to as a fully pressed state).

At the digital camera 10, when the release button 56A is put into the half-pressed state, an AE (automatic exposure) function operates and exposure conditions (shutter speed and an aperture state) are specified, and then an AF (auto focus) function operates to control focusing. Thereafter, when the release button 56A is further put into the fully pressed state, exposure (photography) is performed.

The mode-switching switch 56C is turned for operation when either mode is to be specified of a photography mode, which is a mode for recording image information representing a single still image for a single time of photography, and a replay mode, which is a mode for replaying a subject at an LCD 38.

An eyepiece portion of the aforementioned viewfinder 20, a substantially rectangular liquid crystal display (below referred to as the LCD) 38, which displays photographed subjects, menu images and so forth, and a cross-cursor button 56D are provided at a rear face of the digital camera 10. The cross-cursor button 56D is structured to include four arrow keys for four directions of movement—up, down, left and right—in a display region of the LCD 38.

A menu button, a set button, a cancel button, and a self-timer photography button are also provided at the rear face of the digital camera 10. The menu button is pressed for operation when a menu image is to be displayed at the LCD 38. The set button is pressed for operation when details of a previous control are to be confirmed. The cancel button is pressed for operation when details of the most recent control are to be canceled. The self-timer photography button is pressed for operation when self-timer photography is to be performed.

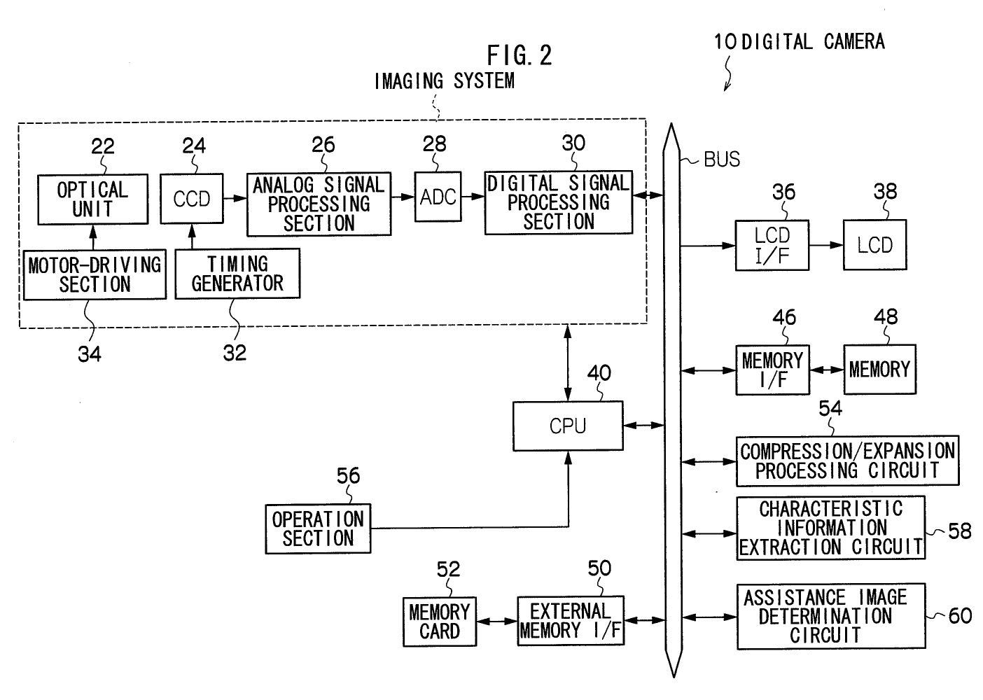

Next, structure of principal elements of an electronic system of the digital camera 10 relating to the present embodiment will be described with reference to FIG. 2.

The digital camera 10 is structured to include an optical unit 22, a charge coupling device (below referred to as a CCD) 24, and an analog signal processing section 26. The optical unit 22 is structured to include the aforementioned lens 21. The CCD 24 is disposed to rearward of the lens 21 on an optical axis thereof. The analog signal processing section 26 performs various kinds of analog signal processing on analog signals that are inputted thereto. Herein, the CCD 24 corresponds to an imaging component of the present invention.

The digital camera 10 is further structured to include an analog/digital converter (below referred to as an ADC) 28 and a digital signal processing section 30. The ADC 28 converts inputted analog signals to digital signals. The digital signal processing section 30 performs various kinds of digital signal processing on digital data that is inputted thereto.

The digital signal processing section 30 incorporates a line buffer with a predetermined capacity, and implements direct memorization of the inputted digital data in a predetermined region of a memory 48, which will be described later.

An output terminal of the CCD 24 is connected to an input terminal of the analog signal processing section 26, an output terminal of the analog signal processing section 26 is connected to an input terminal of the ADC 28, and an output terminal of the ADC 28 is connected to an input terminal of the digital signal processing section 30. Thus, analog signals representing a subject that are outputted from the CCD 24 are subjected to predetermined analog signal processing by the analog signal processing section 26, are converted to digital image information by the ADC 28, and are then inputted to the digital signal processing section 30.

The digital camera 10 is further structured to include an LCD interface 36, a CPU (central processing unit) 40, the memory 48 and a memory interface 46. The LCD interface 36 generates signals for displaying subjects, menu images and so forth at the LCD 38, and provides the signals to the LCD 38. The CPU 40 administers operations of the digital camera 10 as a whole. The memory 48 includes a RAM (random access memory) region, which temporarily stores digital information that has been obtained by imaging, and a ROM (read-only memory) region, at which various control programs to be executed by the CPU 40 and data and the like are memorized. The memory interface 46 implements control of access to the memory 48.

The digital camera 10 is yet further structured to include an external memory interface 50, for enabling access by the digital camera 10 to a portable memory card 52, and a compression/expansion processing circuit 54, which performs compression processing and expansion processing on digital image information.

For the digital camera 10 of the present embodiment, a flash memory is utilized as the memory 48 and a smart media is utilized as the portable memory card 52. Herein, the memory 48 corresponds to a memory component of the present invention.

The digital camera 10 is still further structured to include a characteristic information extraction circuit 58 and an assistance image determination circuit 60. The characteristic information extraction circuit 58 features a characteristic information extraction function which, on the basis of digital image information, extracts characteristic information representing pre-specified characteristics. The assistance image determination circuit 60 features an assistance image determination function which, on the basis of extraction results from the characteristic information extraction circuit 58, determines an assistance image for assisting a determination of composition when a subject is to be photographed. Herein, the characteristic information extraction circuit 58 corresponds to a characteristic information extraction component of the present invention and the assistance image determination circuit 60 corresponds to an assistance image determination component of the present invention.

The digital signal processing section 30, the LCD interface 36, the CPU 40, the memory interface 46, the external memory interface 50, the compression/expansion processing circuit 54, the characteristic information extraction circuit 58 and the assistance image determination circuit 60 are connected to one another through a system bus BUS. Accordingly, the CPU 40 can implement control of operations of the digital signal processing section 30, the compression/expansion processing circuit 54, the characteristic information extraction circuit 58 and the assistance image determination circuit 60, display of various kinds of information at the LCD 38 via the LCD interface 36, and control of access to the memory 48 and the portable memory card 52 via the memory interface 46 and the external memory interface 50.

The digital camera 10 is also provided with a timing generator 32 that generates timing signals, principally for driving the CCD 24, and provides the timing signals to the CCD 24. Driving of the CCD 24 is controlled by the CPU 40, via the timing generator 32.

The digital camera 10 is also provided with a motor-driving section 34. An unillustrated focus adjustment motor, zoom motor and aperture driving motor are provided at the optical unit 22. Driving of these motors is controlled by the CPU 40, via the motor-driving section 34.

That is, the lens 21 relating to the present embodiment includes a plurality of lenses, is structured as a zoom lens with which alterations of a focusing distance (changes in magnification) are possible, and is equipped with an unillustrated lens-driving mechanism. The above-mentioned focus adjustment motor, zoom motor and aperture driving motor are included in this lens-driving mechanism. These motors are each driven by driving signals provided from the motor-driving section 34 in accordance with control by the CPU 40.

The release button 56A, power switch 56B, mode-switching switch 56C, cross-cursor button 56D, and various switches such as the menu button and the like (collectively referred to as the operation section 56 in FIG. 2) are also connected to the CPU 40. Thus, the CPU 40 can continuously ascertain operational states of the operation section 56.

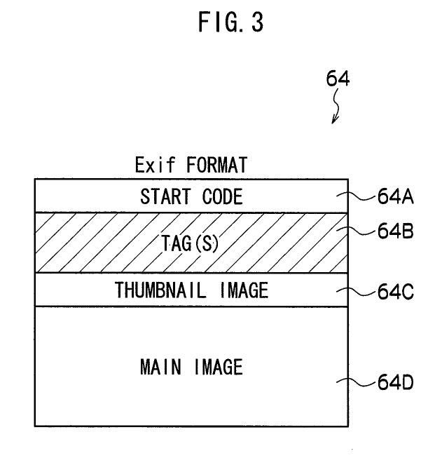

Here, the digital camera 10 relating to the present embodiment supports the Exif format (exchangeable image file format). Image information obtained by photography is memorized at the portable memory card 52 in the form of Exif format electronic files (below referred to as image files) 64, as is schematically shown by the example in FIG. 3. Information that is to be memorized in a tag region 64B included in the Exif format image file 64 is selected in advance from a menu screen, which is displayed at the LCD 38 in accordance with pressing operations of the operation section 56. Thereafter, that information can be memorized in the tag region 64B of each image file 64 obtained by photography.

That is, as shown in FIG. 3, in the digital camera 10 relating to the present embodiment, because the image files 64 obtained by photography and memorized at the portable memory card 52 conform to the Exif format, each image file 64 includes a start code region 64A, the tag region 64B, a thumbnail image region 64C and a main image region 64D.

Next, overall operations of the digital camera 10 relating to the present embodiment at a time of photography will be briefly described.

First, the CCD 24 performs imaging through the optical unit 22, and analog signals for each of R (red), G (green) and B (blue) representing a subject are sequentially outputted to the analog signal processing section 26. The analog signal processing section 26 applies analog signal processing, such as correlated double sampling processing and the like, to the analog signals inputted from the CCD 24, and then sequentially outputs signals to the ADC 28.

The ADC 28 converts the respective analog signals of R, G and B that are inputted from the analog signal processing section 26 to respective 12-bit signals of R, G and B (digital image information), and sequentially outputs the digital image information to the digital signal processing section 30. The digital signal processing section 30 accumulates the digital image information that is sequentially inputted from the ADC 28 into the line buffer incorporated thereat, and directly stores the digital image information to a predetermined region of the memory 48, temporarily.

The digital image information that has been stored in the predetermined region of the memory 48 is read out by the digital signal processing section 30 in accordance with control by the CPU 40. The digital signal processing section 30 performs white balance adjustment by applying digital gain to each of R, G and B in accordance with predetermined physical quantities, performs gamma processing and sharpness processing, and generates 8-bit digital image information.

Then, the digital signal processing section 30 applies YC signal processing to the generated 8-bit digital image information and generates a luminance signal Y and chroma signals Cr and Cb (below referred to as YC signals), and stores the YC signals to a predetermined region of the memory 48 different from the above-mentioned predetermined region.

The LCD 38 is structured to be able to display moving images obtained by continuous imaging by the CCD 24 (through-images) and be utilized as a viewfinder. When the LCD 38 is being utilized as a viewfinder, the generated YC signals are sequentially outputted to the LCD 38 via the LCD interface 36. Thus, the through-images are displayed at the LCD 38.

Then, at a time at which the release button 56A is put into the half-pressed state by a user, the AE function operates as mentioned above and exposure conditions are specified, and then the AF function operates and focusing is controlled. Thereafter, at a time at which the release button 56A is then put into the fully pressed state, the YC signals that are stored in the memory 48 at this point in time are compressed into a predetermined compression format (JPEG format in the present embodiment) by the compression/expansion processing circuit 54, and are then recorded, via the external memory interface 50, to the portable memory card 52 as the image file 64 in the Exif format.

Anyway, in the digital camera 10 relating to the present embodiment, when the photography mode is activated, imaging by the CCD 24 is commenced. Then, at the time of imaging, display control processing is executed to perform processing which: extracts characteristic information representing pre-specified characteristics from the digital image information that has been obtained by the performance of imaging; on the basis of results of this extraction, selects an assistance image to assist a determination of composition when photographing a subject; and controls the LCD 38 such that the assistance image is displayed superimposed with the subject by the LCD 38.

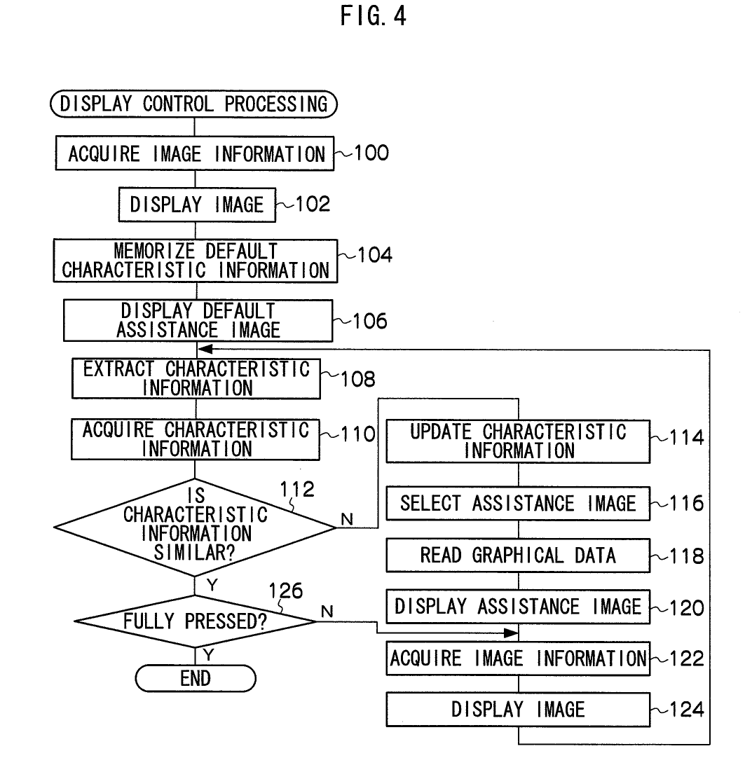

Next, a processing routine of the digital camera 10 when executing the above-mentioned display control processing will be described with reference to FIG. 4. FIG. 4 is a flowchart illustrating a flow of processing of a display control processing program that is executed by the CPU 40 of the digital camera 10 at such a time. This program is memorized in advance in the ROM region of the memory 48.

First, in step 100, when a subject is photographed, digital image information representing the subject is acquired. Next, in step 102, an image represented by the digital image information acquired in step 100 is displayed at the LCD 38. That is, by the processing of step 102, a through-image is displayed at the LCD 38.

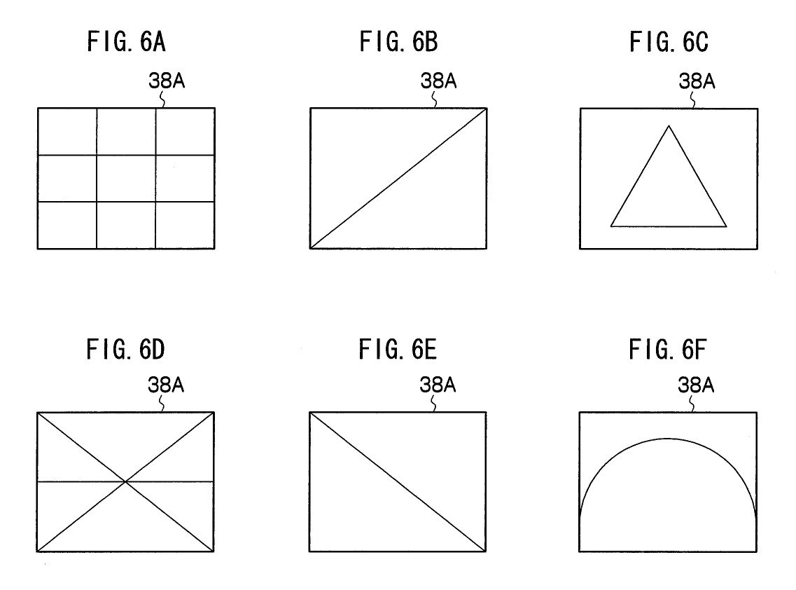

Next, in step 104, default characteristic information, which is memorized in advance, is read out from internal memory of the CPU 40, and this characteristic information is memorized to a predetermined region different from the previously mentioned predetermined regions of the memory 48. In the present embodiment, the default characteristic information accords with a plurality of kinds of characteristic information which correspond to the assistance image illustrated in FIG. 6A, which will be discussed later. In the present embodiment, the characteristic information is data representing outlines of the subject.

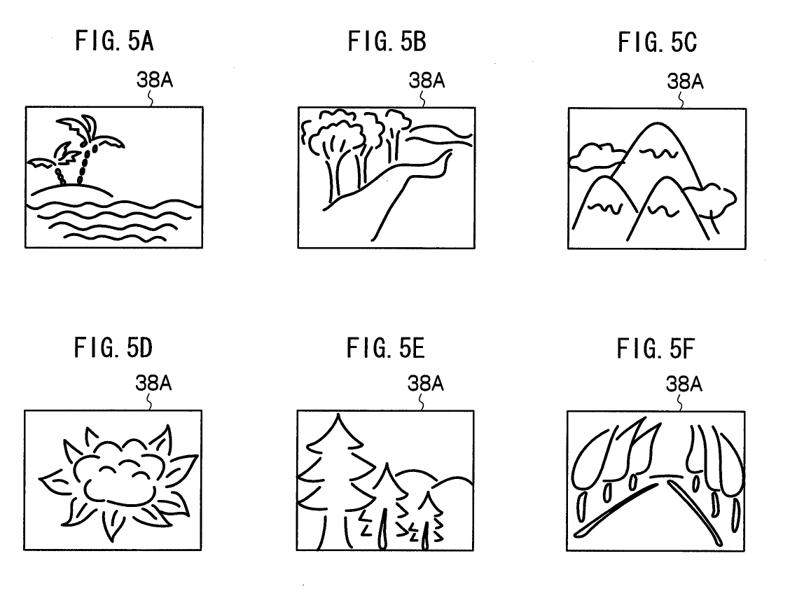

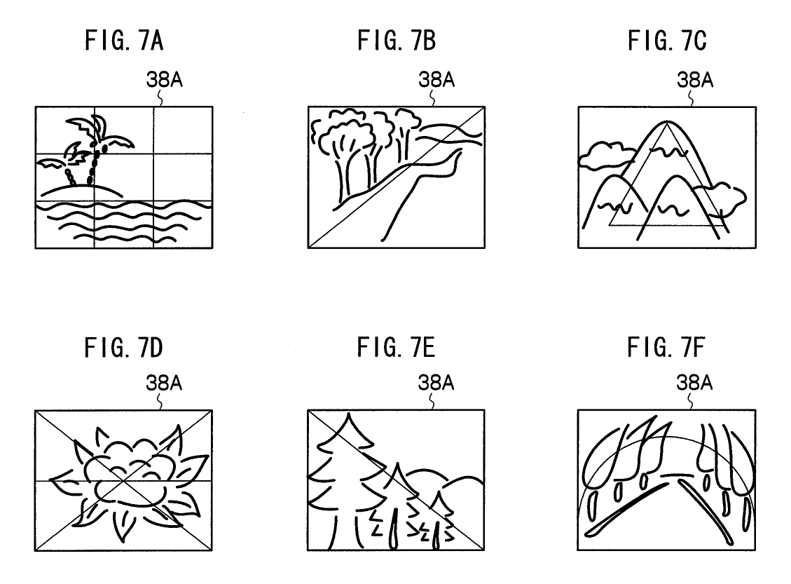

Next, in step 106, a default assistance image corresponding to the characteristic information that has been stored in the memory 48 in step 104 is displayed at the LCD 38. By the processing of step 106, as shown by the example in FIG. 7A, the below-described assistance image shown in FIG. 6A, which serves as the default assistance image, is displayed at a screen 38A of the LCD 38 in a state of being superimposed with a through-image, shown in FIG. 5A. The through-image shown in FIG. 5A has a structure which includes the sea, which appears as horizontal lines, a small island above the horizontal lines of the sea, at the left side in a front view of the screen 38A, and palm trees on the small island. Note that the state of the screen 38A shown in FIG. 7A is merely an example. In the present embodiment, the later-described assistance image shown in FIG. 6A, which is the default assistance image, is displayed by the processing of step 106 regardless of conditions of the through-image.

In the present embodiment, six assistance images are prepared as assistance images which can be displayed at the LCD 38, as shown by the examples in FIG. 6A to FIG. 6F. The assistance image shown in FIG. 6A is an assistance image formed with two straight lines dividing the screen 38A of the LCD 38 into equal thirds in the horizontal direction and two straight lines dividing the screen 38A into equal thirds in the vertical direction. The assistance image shown in FIG. 6B is an assistance image formed with a single straight line joining a front view bottom-left corner with a front view top-right corner of the screen 38A of the LCD 38. The assistance image shown in FIG. 6C is an assistance image formed with three straight lines that form three sides of an equilateral triangle located at a central portion of the screen 38A of the LCD 38. The assistance image shown in FIG. 6D is an assistance image formed with a horizontal line, which divides the screen 38A of the LCD 38 into equal halves in the vertical direction, and two diagonal lines. The assistance image shown in FIG. 6E is an assistance image formed with a single straight line joining a front view top-left corner with a front view bottom-right corner of the screen 38A of the LCD 38. The assistance image shown in FIG. 6F is an assistance image formed with a curve that forms a semi-circular arc of which one end is located at the front view bottom-right corner of the screen 38A of the LCD 38 and the other end is located at the front view bottom-left corner of the screen 38A of the LCD 38.

In step 108, the aforementioned characteristic information extraction function is operated. By the processing of step 108, characteristic information is extracted from the digital image information acquired in step 100.

Next, in step 110, the characteristic information extracted by the processing of step 108 is acquired. Then, in step 112, the default characteristic information that was stored in the memory 48 in step 104 and the characteristic information that was acquired in step 110 are compared, and it is judged whether or not these sets of characteristic information are similar (including matching). If this judgment is positive, the routine proceeds to step 126, while if this judgment is negative, the routine proceeds to step 114.

In step 114, the pre-specified characteristic information that was stored in the memory 48 in step 104 is updated to the characteristic information that was acquired in step 110.

Next, in step 116, the aforementioned assistance image determination function is operated, and thus an assistance image that corresponds to the characteristic information to which the characteristic information was updated in step 114 is selected from the six assistance images shown in FIG. 6A to FIG. 6F. As a method for selecting the assistance image that corresponds to the characteristic information, the present embodiment employs a method in which a table is memorized beforehand in the memory 48, for which table the characteristic information is an input and data representing a type of assistance image is an output, and the assistance image is selected using this table.

In the present embodiment, in the table, a plurality of kinds of characteristic information are associated with the assistance image shown in FIG. 6A, for which types of characteristic information display of the assistance image shown in FIG. 6A at the LCD 38 would be favorable in assisting a determination of composition when photographing a subject. A plurality of kinds of characteristic information for which display of the assistance image shown in FIG. 6B at the LCD 38 would be favorable in assisting a determination of composition when photographing a subject are associated with the assistance image shown in FIG. 6B; a plurality of kinds of characteristic information for which display of the assistance image shown in FIG. 6C at the LCD 38 would be favorable in assisting a determination of composition when photographing a subject are associated with the assistance image shown in FIG. 6C; a plurality of kinds of characteristic information for which display of the assistance image shown in FIG. 6D at the LCD 38 would be favorable in assisting a determination of composition when photographing a subject are associated with the assistance image shown in FIG. 6D; a plurality of kinds of characteristic information for which display of the assistance image shown in FIG. 6E at the LCD 38 would be favorable in assisting determination of a composition when photographing a subject are associated with the assistance image shown in FIG. 6E; and a plurality of kinds of characteristic information for which display of the assistance image shown in FIG. 6F at the LCD 38 would be favorable in assisting determination of a composition when photographing a subject are associated with the assistance image shown in FIG. 6F.

Thus, if, for example, the characteristic information to which the characteristic information was updated in step 114 is one of the plurality of kinds of characteristic information for which display of the assistance image shown in FIG. 6B at the LCD 38 would be favorable for assisting determination of a composition when photographing the subject, then the assistance image shown in FIG. 6B will be selected by the processing of step 116.

Here, graphical data for displaying the assistance images shown in FIG. 6A to FIG. 6F at the LCD 38 is stored in the memory 48 in advance.

In step 118, graphical data corresponding to the assistance image that was selected in step 116 is read out from the memory 48.

Next, in step 120, the assistance image represented by the graphical data that was read out in step 118 is displayed at the LCD 38, superimposed with the through-image.

Now, as shown by the example in FIG. 5B, in a case in which an image that serves as a through-image and is displayed at the screen 38A of the LCD 38 shows a road stretching from substantially the front view bottom-left corner of the screen 38A to substantially the front view top-right corner of the screen: the assistance image shown in FIG. 6B is selected by the processing of step 116; and, as shown in FIG. 7B, the assistance image shown in FIG. 6B is displayed at the screen 38A of the LCD 38, in a state which is superimposed with the through-image of FIG. 5B, by the processing of step 118.

Further, as shown by the example in FIG. 5C, in a case in which the image which is the through-image and is displayed at the screen 38A of the LCD 38 shows mountains with fan-like shapes: the assistance image shown in FIG. 6C is selected by the processing of step 116; and, as shown in FIG. 7C, the assistance image shown in FIG. 6C is displayed at the screen 38A of the LCD 38, having been superimposed with the through-image of FIG. 5C, by the processing of step 118 and step 120.

Further, as shown by the example in FIG. 5D, in a case in which the image which is the through-image and is displayed at the screen 38A of the LCD 38 shows a situation in which a flower is central and leaves are growing radially from the root of the flower: the assistance image shown in FIG. 6D is selected by the processing of step 116; and, as shown in FIG. 7D, the assistance image shown in FIG. 6D is displayed at the screen 38A of the LCD 38, having been superimposed with the through-image of FIG. 5D, by the processing of step 118 and step 120.

Further, as shown by the example in FIG. 5E, in a case in which the image which is the through-image and is displayed at the screen 38A of the LCD 38 shows trees with heights gradually diminishing from the front view left side of the screen 38A to the front view right side of the screen 38A: the assistance image shown in FIG. 6E is selected by the processing of step 116; and, as shown in FIG. 7E, the assistance image shown in FIG. 6E is displayed at the screen 38A of the LCD 38, having been superimposed with the through-image of FIG. 5E, by the processing of step 118 and step 120.

Further, as shown by the example in FIG. 5F, in a case in which the image which is the through-image and is displayed at the screen 38A of the LCD 38 shows a situation in which a number of roadside trees are growing along a road which extends from the foreground into the background: the assistance image shown in FIG. 6F is selected by the processing of step 116; and, as shown in FIG. 7F, the assistance image shown in FIG. 6F is displayed at the screen 38A of the LCD 38, having been superimposed with the through-image of FIG. 5F, by the processing of step 118 and step 120.

In step 122, processing the same as in step 100 is performed. Then, in step 124, processing the same as in step 102 is performed. When the processing of step 124 finishes, the routine returns to step 108.

On the other hand, in step 126, it is judged whether or not the release button 56A has been put into the fully pressed state. If this judgment is negative, the routine proceeds to step 122, while if this judgment is positive, the present display control processing program ends.

Herein, step 100 of the present display control processing program corresponds to a step of imaging of the present invention, step 108 corresponds to a step of extracting characteristic information of the present invention, step 112 corresponds to a judgment component of the present invention, step 116 corresponds to a step of determining an assistance image of the present invention, and step 120 corresponds to a control component and a step of implementing control of the present invention.

### SECOND EMBODIMENT

For the second embodiment, an embodiment of the display control processing program which differs from the display control processing program described for the first embodiment will be described. Structure of the digital camera 10 relating to the second embodiment is the same as the structure described for the first embodiment (see FIG. 1 to FIG. 3), so descriptions thereof will not be given here.

In the digital camera 10 relating to the second embodiment, when the photography mode is activated, imaging by the CCD 24 is commenced. Then, at the time of imaging, display control processing is executed to perform processing which: extracts characteristic information representing pre-specified characteristics from the digital image information obtained by the performance of imaging; on the basis of results of this extraction, creates an assistance image to assist a determination of composition for when photographing the subject; and controls the LCD 38 such that the assistance image is displayed superimposed with the subject by the LCD 38.

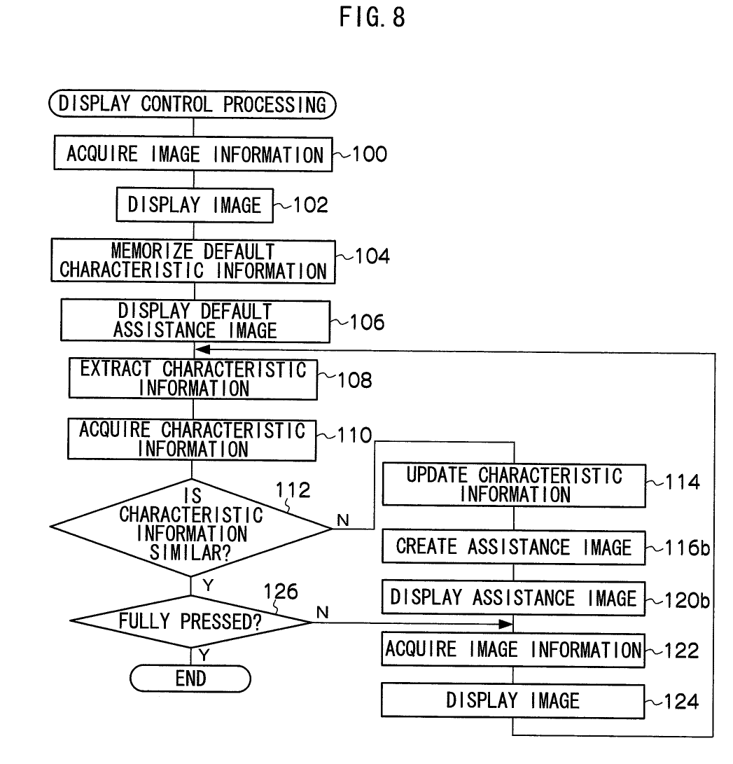

Herebelow, a processing routine of the digital camera 10 when executing the display control processing relating to the second embodiment will be described with reference to FIG. 8. FIG. 8 is a flowchart illustrating a flow of processing of the display control processing program that is executed by the CPU 40 of the digital camera 10 at such a time. This program is memorized in advance in the ROM region of the memory 48. Steps that perform the same processing in FIG. 8 as in FIG. 4 are assigned the same reference numerals as in FIG. 4, and descriptions thereof are greatly abbreviated.

Firstly, the processing from step 100 to step 110 described for the first embodiment is executed in sequence. When the processing of step 110 finishes, the routine advances to step 112. If the judgment of step 112 is positive, the routine proceeds to step 126, while if the judgment of step 112 is negative, the routine proceeds to step 114. In step 114, processing the same as in the first embodiment is performed. When the processing of step 114 finishes, the routine proceeds to step 116b.

In step 116b, the aforementioned assistance image determination function is operated, and thus an assistance image is created on the basis of the characteristic information to which the characteristic information was updated in step 114. When the processing of step 116b finishes, the routine proceeds to step 120b.

Here, as a method for creating the assistance image corresponding to the characteristic information, the second embodiment employs a method which generates graphical data representing lines similar to (and possibly matching) outlines along outlines of the subject, on the basis of the characteristic information to which the characteristic information was updated in step 114.

Next, in step 120b, the assistance image created in step 116b is displayed at the LCD 38, superimposed with the through-image.

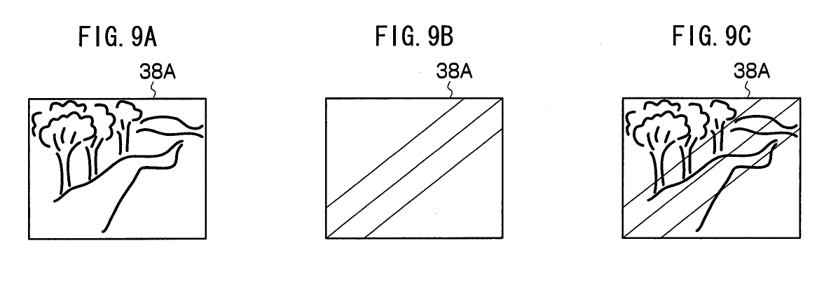

Here, as shown by the example in FIG. 9A, in a case in which an image that serves as a through-image and is displayed at the screen 38A of the LCD 38 shows a road stretching from substantially the front view bottom-left corner of the screen 38A to substantially the front view top-right corner of the screen 38A: an assistance image formed with three lines joining the front view bottom-left corner of the screen 38A with the front view top-right corner of the screen 38A, as shown in FIG. 9B, is created by the processing of step 116b; and, as shown in FIG. 9C, the assistance image shown in FIG. 9B is displayed at the screen 38A of the LCD 38, in a state which is superimposed with the through-image of FIG. 9A, by the processing of step 120b.

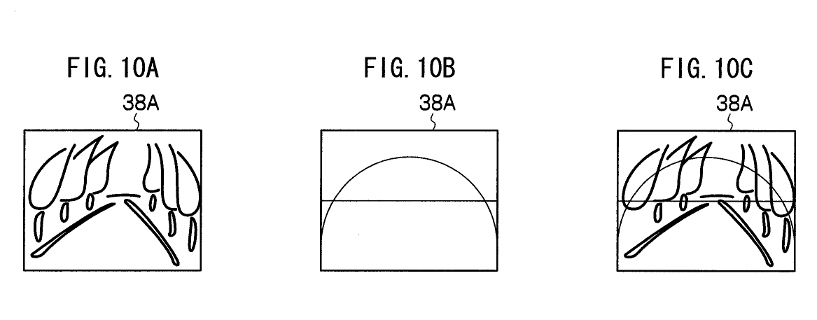

Further, as shown by the example in FIG. 10A, in a case in which an image that serves as a through-image and is displayed at the screen 38A of the LCD 38 shows a situation in which a number of roadside trees are growing along a road which extends from the foreground into the background: an assistance image formed with a curve that forms a semi-circular arc of which one end is located at the front view bottom-right corner of the screen 38A of the LCD 38 and the other end is located at the front view bottom-left corner of the screen 38A of the LCD 38 and with a straight line that divides the screen 38A of the LCD 38 into equal halves in the vertical direction, as shown in FIG. 10B, is created by the processing of step 116b; and, as shown in FIG. 10C, the assistance image shown in FIG. 10B is displayed at the screen 38A of the LCD 38, having been superimposed with the through-image of FIG. 10A, by the processing of step 120b.

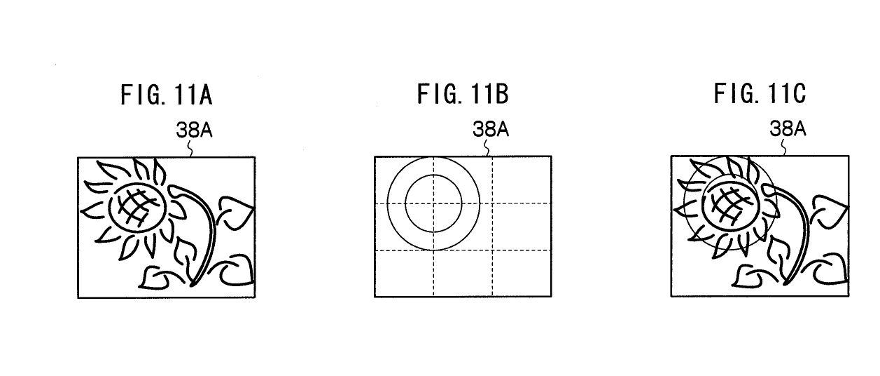

Further, as shown by the example in FIG. 11A, in a case in which an image that serves as a through-image and is displayed shows a flower with a substantially circular outline at a front view top-left portion of the screen 38A of the LCD 38: an assistance image formed with two concentric circles that are centered on, of four intersections at which two straight lines dividing the screen 38A of the LCD 38 into equal thirds in the horizontal direction (see the broken lines in FIG. 11B) and two straight lines dividing the screen 38A of the LCD 38 into equal thirds in the vertical direction (see the broken lines in FIG. 11B) intersect, the intersection at the front view upper left of the screen 38A, as shown in FIG. 11B, is created by the processing of step 116b; and, as shown in FIG. 11C, the assistance image shown in FIG. 11B is displayed at the screen 38A of the LCD 38, having been superimposed with the through-image of FIG. 11A, by the processing of step 120b.

When the processing of step 120b finishes, the processing from step 122 to step 124 described for the first embodiment is executed in sequence.

Anyway, in step 126, if the judgment thereof is negative, the routine proceeds to step 122, while if this judgment is positive, the present display control processing program ends.

Herein, step 116b of the present display control processing program corresponds to the step of determining an assistance image of the present invention, and step 120b corresponds to the control component and the step of implementing control of the present invention.

### THIRD EMBODIMENT

For the third embodiment, an embodiment of the display control processing program which differs from the display control processing program described for the second embodiment will be described. Structure of the digital camera 10 relating to the third embodiment is the same as the structure described for the first embodiment (see FIG. 1 to FIG. 3), so descriptions thereof will not be given here.

In the digital camera 10 relating to the third embodiment, when the photography mode is activated, imaging by the CCD 24 is commenced. Then, at the time of imaging, display control processing is executed to perform processing which: extracts characteristic information representing pre-specified characteristics from the digital image information obtained by the performance of imaging; on the basis of results of this extraction, determines an assistance image to assist a determination of composition for when photographing the subject; and partially alters a state of the assistance image on the basis of the extraction results and controls the LCD 38 such that the assistance image is displayed superimposed with the subject by the LCD 38.

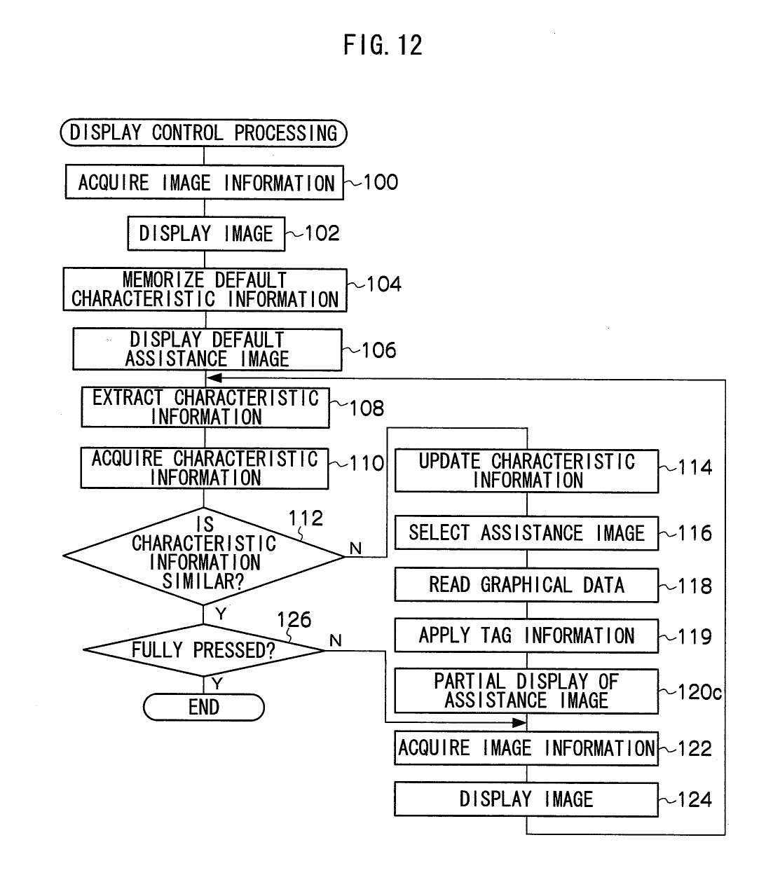

Herebelow, a processing routine of the digital camera 10 when executing the display control processing relating to the third embodiment will be described with reference to FIG. 12. FIG. 12 is a flowchart illustrating a flow of processing of the display control processing program that is executed by the CPU 40 of the digital camera 10 at such a time. This program is memorized in advance in the ROM region of the memory 48. Steps that perform the same processing in FIG. 12 as in FIG. 4 are assigned the same reference numerals as in FIG. 4, and descriptions thereof are greatly abbreviated.

The processing from step 100 to step 110 described for the first embodiment is executed in sequence. When the processing of step 110 finishes, the routine advances to step 112. If the judgment of step 112 is positive, the routine proceeds to step 126, while if the judgment of step 112 is negative, the routine proceeds to step 114. In step 114, processing the same as in the first embodiment is performed. When the processing of step 114 finishes, the routine proceeds to step 116. In step 116 and step 118, processing the same as in the first embodiment is performed. When the processing of step 118 finishes, the routine proceeds to step 119.

In step 119, on the basis of the characteristic information, the assistance image is categorized into portions that are to be emphasized in display at the LCD 38 and other portions. Of the graphical data that was read out in step 118, tag information representing emphasized display is applied to data that corresponds to the portions that are to be emphasized in display.

In step 120c, the assistance image that was determined in step 116 is partially altered in state in accordance with the tag information, and the assistance image is displayed superimposed with the through-image.

Now, if the assistance image shown in FIG. 6A were to be selected by the processing of step 116 and this assistance image were to be displayed superimposed with the through-image without regard to tag information, then as shown in FIG. 7A, the assistance image shown in FIG. 6A would be displayed in a state of being superimposed with the through-image shown in FIG. 5A.

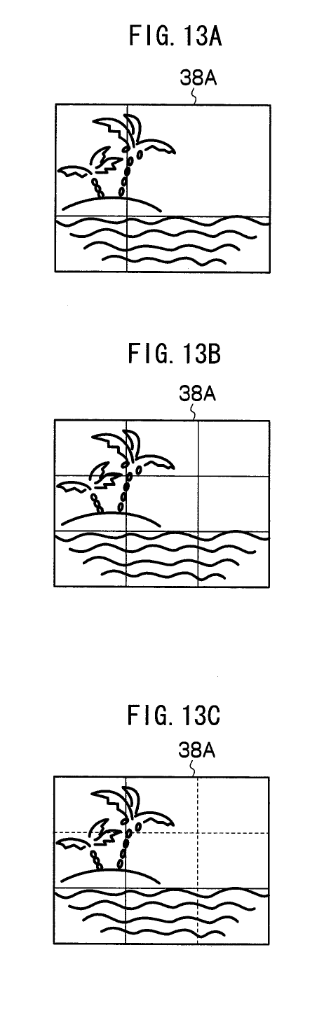

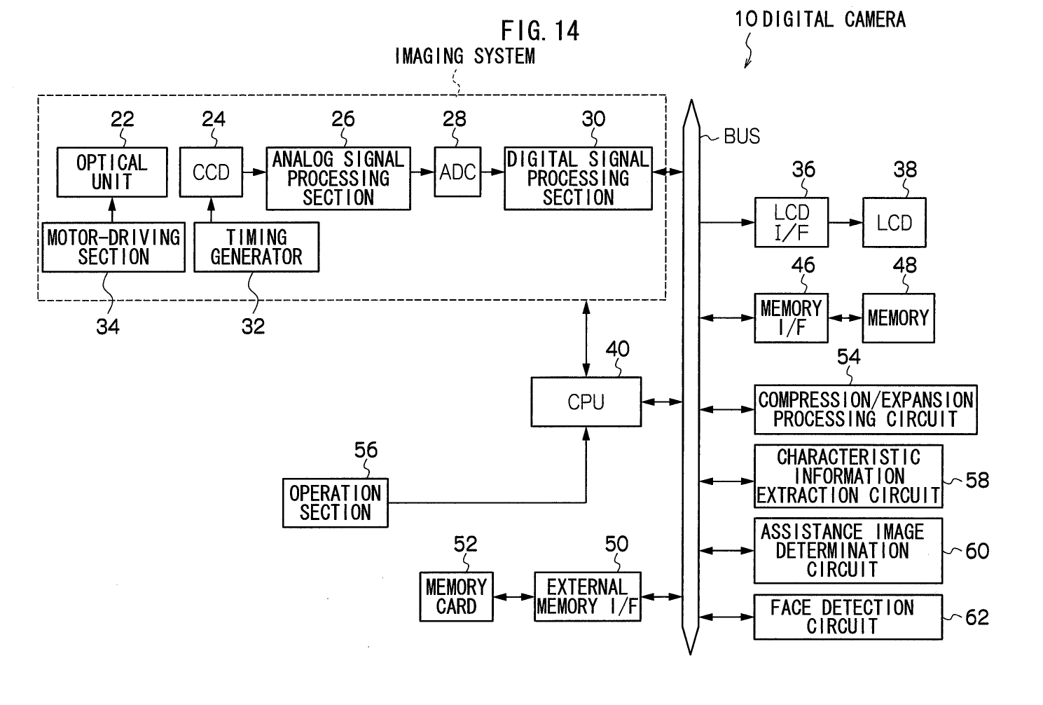

Here however, for example, for the assistance image shown in FIG. 6A, tag information is applied to graphical data representing, of the two lines dividing the screen 38A of the LCD 38 into equal thirds in the vertical direction, the lower line in front view of the LCD 38, and to graphical data representing, of the two lines dividing the screen 38A of the LCD 38 into equal thirds in the horizontal direction, the left line in front view of the LCD 38. In this case, as shown in FIG. 13A, an assistance image represented only by the graphical data to which the tag information has been applied will be displayed at the screen 38A of the LCD 38, superimposed with the through-image.

Now, this mode in which an assistance image represented only by graphical data to which tag information has been applied is displayed superimposed with a through-image at the screen 38A of the LCD 38 is no more than an example. Other embodiments include: an embodiment in which, as shown in FIG. 13B, an assistance image represented by graphical data to which tag information has been applied is displayed with usual heavy lines and an assistance image represented by graphical data to which tag information has not been applied is displayed with lines narrower than the usual heavy lines; an embodiment in which, as shown in FIG. 13C, assistance image represented by graphical data to which tag information has been applied is displayed with solid lines and an assistance image represented by graphical data to which tag information has not been applied is displayed by broken lines; and an embodiment in which an assistance image represented by graphical data to which tag information has been applied is flashingly displayed and an assistance image represented by graphical data to which tag information has not been applied is not displayed.

When the processing of step 120c finishes, the processing from step 122 to step 124 described for the first embodiment is executed in sequence.

Anyway, in step 126, if the judgment thereof is negative, the routine proceeds to step 122, while if this judgment is positive, the present display control processing program ends.

Herein, step 120c of the present display control processing program corresponds to the control component and the step of implementing control of the present invention.

### FOURTH EMBODIMENT

For the fourth embodiment, an embodiment for a case in which a subject includes a person's face will be described. Structure of a digital camera relating to the fourth embodiment is the same as the structure described for the first embodiment (see FIG. 1 to FIG. 3) apart from structure of a face detection circuit 62, which will be described below, so descriptions of portions other than the face detection circuit 62 will not be given here.

Next, with reference to FIG. 14, of structure of principal elements of the electronic system of the digital camera 10 relating to the fourth embodiment, only portions that differ from the first embodiment will be described.

The digital camera 10 is structured to include the face detection circuit 62, which features a function that detects a face of a person from digital image data memorized at the memory 48 (below referred to as a face detection function). The face detection circuit 62 is connected to the system bus BUS. Thus, the CPU 40 can implement control of operations of the face detection circuit 62.

For the face detection function relating to the fourth embodiment, for example, a range of color difference signals (chroma signals) that correspond to human skin colors is determined beforehand. By judging whether or not color difference signals of pixels of digital image information, which represents a subject that has been acquired by imaging by the CCD 24, are within this range, the presence or absence of skin colors is judged, and continuous regions including skin colors are extracted to serve as skin color regions. Then, it is judged whether or not patterns which are not skin colors, such as eyes, a nose, a mouth, shoulders, etc., are included at pre-specified positional ranges within a skin color region. If such patterns are included, then the skin color region is judged to be a face region. Hence, if a face region has been judged to be present, the characteristic information extraction circuit 58 extracts data representing the face region.

As a method for judging the face region other than the method described above, it is also possible to utilize a method of looking for clusters in a two-dimensional histogram of hue and chroma and judging face regions from internal structures, shapes and external connecting structures of the clusters, as described in JP-A Nos. 5-100328 and 5-165120, or the like.

Anyway, in the digital camera 10 relating to the fourth embodiment, when the photography mode is activated, imaging by the CCD 24 commences. Then, at the time of imaging, display control processing is executed to perform processing as follows. In a case in which face characteristic information representing characteristics of a person's face has been extracted from the digital image information obtained by the performance of imaging, a face photography assistance image, for assisting a determination of composition when photographing the person's face, is determined. When general subject characteristic information representing characteristics of the subject other than a person's face has been extracted, a general assistance image other than the face photography assistance image is determined. Then, in a case in which a face photography assistance image and a general assistance image have been determined, the LCD 38 is controlled such that the general assistance image is displayed superimposed with the subject by the LCD 38 and the face photography assistance image is displayed at a location of the person's face by the LCD 38.

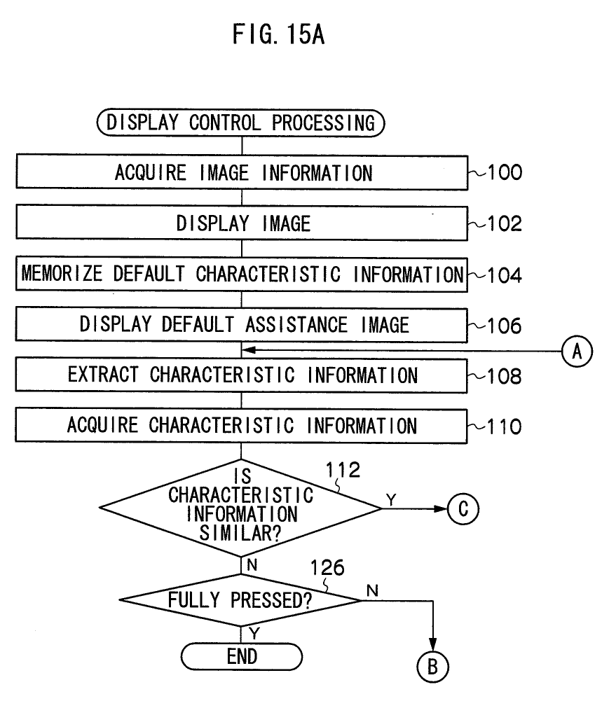

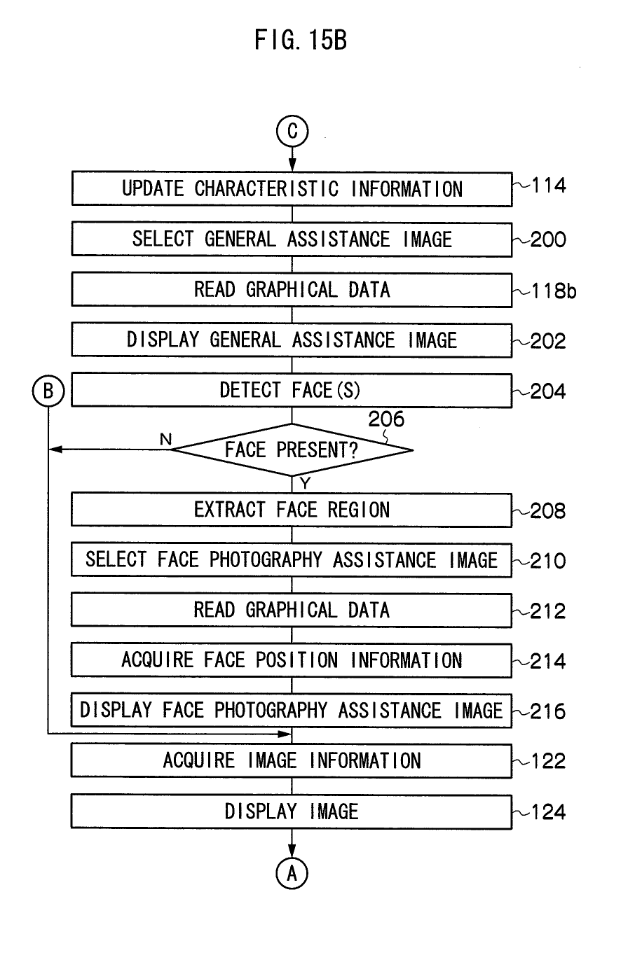

Herebelow, a processing routine of the digital camera 10 when executing the display control processing relating to the fourth embodiment will be described with reference to FIG. 15A and FIG. 15B. FIG. 15A and FIG. 15B are a flowchart illustrating a flow of processing of a display control processing program that is executed by the CPU 40 of the digital camera 10 at such a time. This program is memorized in advance in the ROM region of the memory 48. Steps that perform the same processing in FIG. 15A and FIG. 15B as in FIG. 4 are assigned the same reference numerals as in FIG. 4, and descriptions thereof are greatly abbreviated.

Firstly, the processing from step 100 to step 112 described for the first embodiment is executed in sequence. If the judgment of step 112 is negative, the routine proceeds to step 114, while if the judgment of step 112 is positive, the routine proceeds to step 126. In step 114, processing the same as in the first embodiment is executed. When the processing of step 114 finishes, the routine proceeds to step 200.

In step 200, the aforementioned assistance image determination function is operated, and thus a general assistance image is selected on the basis of the characteristic information to which the characteristic information was updated in step 114. In the fourth embodiment, for example, the six assistance images shown in FIG. 6A to FIG. 6F are referred to as the general assistance images. Moreover, in the fourth embodiment, a method similar to the method for selecting an assistance image that was described earlier for the first embodiment is employed as a method for selecting a general assistance image that corresponds to the characteristic information.

Here, graphical data for displaying the general assistance images shown in FIG. 6A to FIG. 6F at the LCD 38 is stored in the memory 48 in advance.

Next, in step 118b, graphical data corresponding to the general assistance image that was selected in step 200 is read out from the memory 48. Then, in step 202, the general assistance image represented by the graphical data that was read out in step 118b is displayed at the LCD 38, superimposed with the through-image. For this fourth embodiment, the general assistance image shown in FIG. 6A will be used as an example.

Next, in step 204, the above-described face detection function is operated. The presence or absence of a person's face is detected by the face detection function from digital image data that has been memorized at the memory 48. Then, in step 206, it is judged whether or not a person's face is present. If this judgment is positive, the routine proceeds to step 208, while if the judgment is negative, the routine proceeds to step 122.

Next, in step 208, the earlier-described characteristic information extraction function operates. Face region data representing a face region is extracted from the digital image data memorized at the memory 48 by this characteristic information extraction function.

Here, in the digital camera 10 relating to the fourth embodiment, a plurality of types of face photography assistance image (ellipses with mutually different sizes) will have been prepared beforehand.

Next, in step 210, the aforementioned assistance image determination function operates, and thus a face photography assistance image that corresponds to the face region data that was extracted in step 208 is selected from the plurality of types of face photography assistance image. As a method for selecting the face photography assistance image that corresponds to the face region data, the fourth embodiment employs a method in which a table is memorized beforehand in the memory 48, for which table the face region data is an input and data representing a type of face photography assistance image is an output, and the face photography assistance image is selected using this table.

Here, graphical data for displaying the face photography assistance images at the LCD 38 is stored in the memory 48 in advance.

In step 212, graphical data corresponding to the face photography assistance image that has been selected in step 210 is read out from the memory 48.

Next, in step 214, information of the location of a center of the above-mentioned face region in the subject obtained by imaging by the CCD 24 (below referred to as face position information) is acquired.

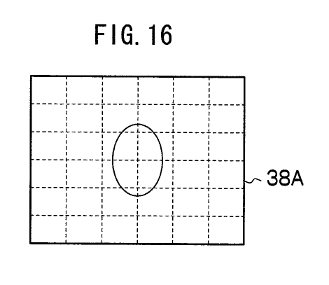

Here, respective weightings are applied to 25 intersections at which five straight lines which divide the screen 38A of the LCD 38 into equal sixths in the horizontal direction and five straight lines which divide the screen 38A of the LCD 38 into equal sixths in the vertical direction intersect, as shown in FIG. 16. The face photography assistance image (in the fourth embodiment, an ellipse) is disposed to be centered on one of these intersections. Herein, of these 25 intersections, the same weighting α is applied to an intersection at the center of the screen 38A and four intersections at which the two lines that divide the screen 38A of the LCD 38 into equal thirds in the horizontal direction and the two lines that divide the screen 38A of the LCD 38 into equal thirds in the vertical direction intersect, and a weighting β, which is smaller than the weighting α, is applied to the other intersections.

Next, in step 216, the face photography assistance image represented by the graphical data that was read out in step 212 is displayed at the LCD 38, superimposed with the through-image in accordance with the face position information that was acquired in step 214.

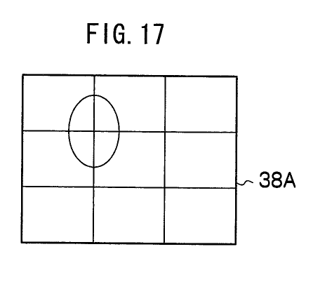

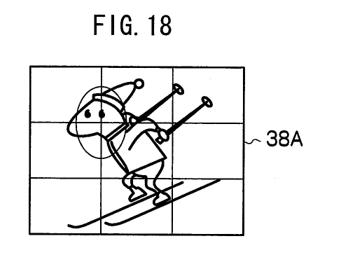

By the processing of step 216, in a case in which, for example, the center of the face region is disposed substantially between the middle of the screen 38A of the LCD 38 and a front view top-left corner of the screen 38A of the LCD 38, then as shown in FIG. 17, the face photography assistance image is displayed at the screen 38A of the LCD 38 so as to be disposed at, of the four intersections at which the two lines that divide the screen 38A of the LCD 38 into equal thirds in the horizontal direction and the two lines that divide the screen 38A of the LCD 38 into equal thirds in the vertical direction intersect, the intersection at the upper left in front view of the screen 38A. Hence, as shown by the example in FIG. 18, the general assistance image is displayed superimposed with the through-image and the face photography assistance image is displayed to accord with the location of a person's face on the screen 38A of the LCD 38.

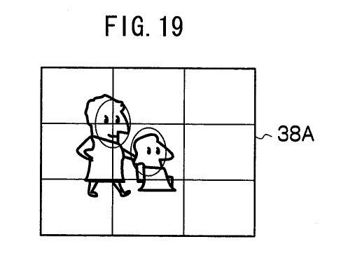

Anyway, for the fourth embodiment, an embodiment for a case in which there is one face region has been described. However, the present invention is not limited thus, and there may be two or more face regions. For example, if, as shown in FIG. 19, a child's face is disposed at a central portion of the screen 38A of the LCD 38 and an adult's face (i.e., a face larger than the child's face) is disposed substantially between the middle of the screen 38A of the LCD 38 and the front view top-left corner of the screen 38A, then a face photography assistance image corresponding to the size of the child's face is displayed at the screen 38A of the LCD 38 such that the center thereof is disposed at the center of the screen 38A of the LCD 38, and a face photography assistance image corresponding to the size of the adult's face is displayed at the screen 38A of the LCD 38 such that the center thereof is disposed at, of the four intersections at which the two lines that divide the screen 38A of the LCD 38 into equal thirds in the horizontal direction and the two lines that divide the screen of the LCD 38 into equal thirds in the vertical direction intersect, the intersection at the upper left in front view of the screen 38A.

When the processing of step 216 finishes, the processing from step 122 to step 124 described for the first embodiment is executed in sequence.

Anyway, in step 126, if the judgment thereof is negative, the routine proceeds to step 122, while if this judgment is positive, the present display control processing program ends.

Herein, step 200 and step 210 of the present display control processing program correspond to the step of determining an assistance image of the present invention, and step 202 and step 216 correspond to the control component and the step of implementing control of the present invention.

### FIFTH EMBODIMENT

For the fifth embodiment, an embodiment for a case in which a person's face is included in a subject and an orientation of the face crosses an imaging direction will be described. Structure of the digital camera 10 relating to the fifth embodiment is the same as the structure relating to the fourth embodiment (see FIG. 1, FIG. 3 and FIG. 14), so descriptions thereof will not be given here.

In the digital camera 10 relating to the fifth embodiment, when the photography mode is activated, imaging by the CCD 24 commences. Then, at the time of imaging, display control processing is executed to perform processing as follows. In a case in which face characteristic information representing characteristics of a person's face—including orientation information representing an orientation of the person's face—has been extracted from the digital image information obtained by the performance of imaging, a face photography assistance image, for assisting a determination of composition when photographing the person's face, is determined. When general subject characteristic information representing characteristics of the subject other than a person's face has been extracted, a general assistance image other than the face photography assistance image is determined. Then, in a case in which a face photography assistance image and a general assistance image have been determined and the orientation of the person's face represented by the orientation information crosses an imaging direction, the LCD 38 is controlled such that the general assistance image is displayed superimposed with the subject by the LCD 38 and the face photography assistance image is displayed by the LCD 38 at a location such that a space at the side of the orientation of the person's face is broader than a space at a side of the face photography assistance image that is opposite from the side of the orientation.

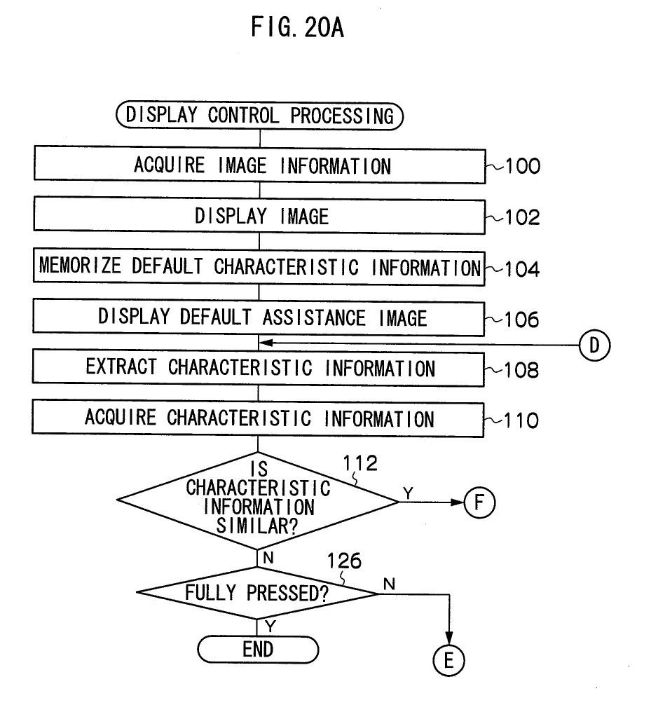

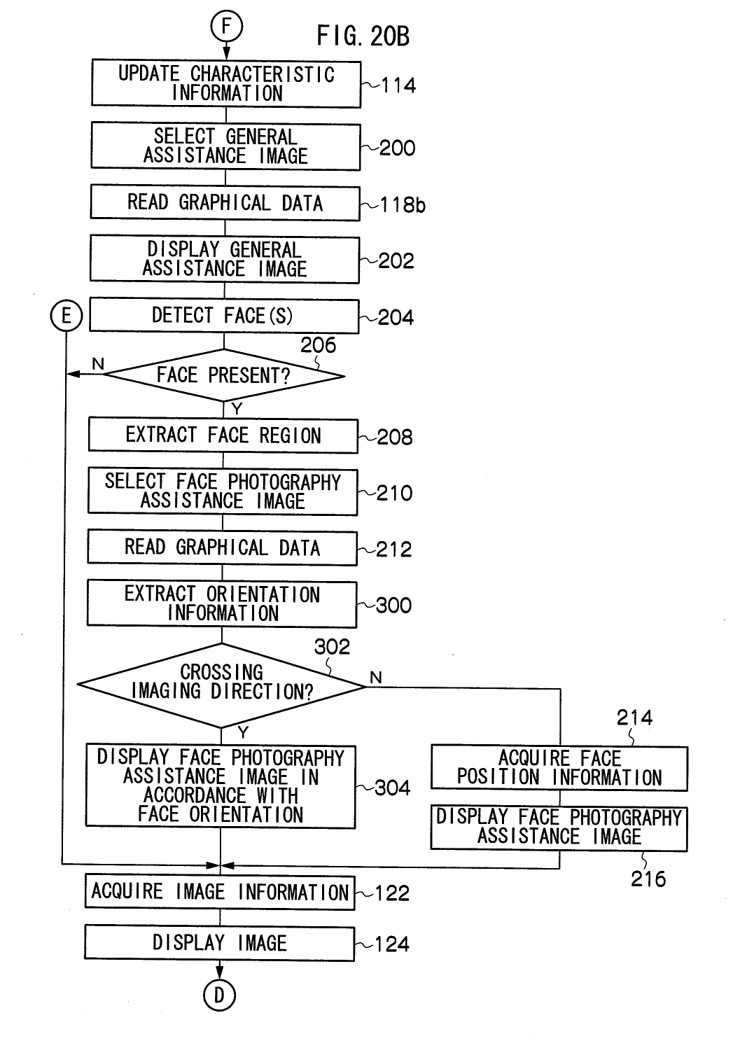

Herebelow, a processing routine of the digital camera 10 when executing the display control processing relating to the fifth embodiment will be described with reference to FIG. 20A and FIG. 20B. FIG. 20A and FIG. 20B are a flowchart illustrating a flow of processing of a display control processing program that is executed by the CPU 40 of the digital camera 10 at such a time. This program is memorized in advance in the ROM region of the memory 48. Steps that perform the same processing in FIG. 20A and FIG. 20B as in FIG. 15A and FIG. 15B are assigned the same reference numerals as in FIG. 15A and FIG. 15B, and descriptions thereof are greatly abbreviated.

Firstly, the processing from step 100 to step 112 described for the fourth embodiment is executed in sequence. If the judgment of step 112 is negative, the routine proceeds to step 114, while if the judgment of step 112 is positive, the routine proceeds to step 126.

In step 114, processing the same as in the fourth embodiment is executed. When the processing of step 114 finishes, the routine proceeds to step 200. From step 200 to step 206, processing the same as in the fourth embodiment is executed in sequence. If the judgment in step 206 is positive, the routine proceeds to step 208, while if the judgment is negative, the routine proceeds to step 122.

From step 208 to step 212, processing the same as in the fourth embodiment is executed in sequence. When the processing of step 212 finishes, the routine proceeds to step 300.

In step 300, the aforementioned characteristic information extraction function operates. An orientation of a person's face is analyzed from face region data and orientation information representing the orientation of the person's face is extracted by the characteristic information extraction function. As a method for analyzing the orientation of a person's face from the face region data, it is possible to employ well-known techniques, such as analyzing the orientation of the person's face from the face region data by combining, for example, a technology which extracts a hair portion from dark areas in the image (areas with densities higher than a threshold value) and extracts lines corresponding to an outline of the face region on the basis of the shape of the hair portion, as described in JP-A Nos. 8-184925 and 2001-218020 and the like, with a technology which extracts two eyes, which are dark areas in the face region, and detects positions of the two eyes in the face region, as described in JP-A No. 2001-218020.

Next, in step 302, it is judged whether or not the face orientation represented by the orientation information extracted in step 300 crosses an orientation of the imaging direction. If this judgment is positive, the routine proceeds to step 304, while if the judgment is negative, the routine proceeds to step 214. In step 214, the same processing as in the fourth embodiment is performed. Then, in step 216 too, the same processing as in the fourth embodiment is performed. When the processing of step 216 finishes, the routine proceeds to step 122.

In step 304, processing is performed which displays the face photography assistance image at the LCD 38 in accordance with the face orientation represented by the orientation information that was extracted in step 300. By the processing of step 304, the face photography assistance image is displayed at the screen 38A of the LCD 38 at a location such that there is a wider space to the side of the face orientation represented by the orientation information extracted in step 300 than to the opposite side from the face orientation side.

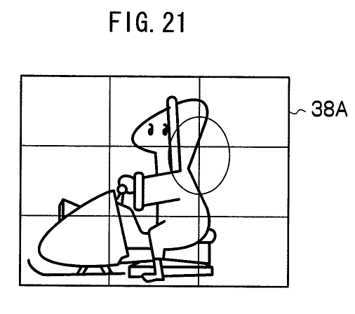

For example, in a case in which, as shown in FIG. 21, a face oriented to the front view left side of the screen 38A is displayed at a middle portion of the screen 38A and the general assistance image shown in FIG. 6A is displayed at the screen 38A of the LCD 38 superimposed with a through-image, a face photography assistance image is displayed at the screen 38A of the LCD 38 so as to be positioned at, of the four intersections at which the two lines that divide the screen 38A of the LCD 38 into equal thirds in the horizontal direction and the two lines that divide the screen 38A of the LCD 38 into equal thirds in the vertical direction intersect, the intersection at the upper right in front view of the screen 38A. Therefore, referring from the position at which the face photography assistance image is displayed, a space to the front view left side is wider than a space to the front view right side.

When the processing of step 304 finishes, the processing from step 122 to step 124 described for the first embodiment is executed in sequence.

Anyway, in step 126, if the judgment thereof is negative, the routine proceeds to step 122, while if this judgment is positive, the present display control processing program ends.

Herein, step 304 of the present display control processing program corresponds to the control component and the step of implementing control of the present invention.

### SIXTH EMBODIMENT

For the sixth embodiment, an embodiment for a case in which a person's face is included in a subject and an assistance image is displayed with an orientation corresponding to an orientation of the face will be described. Structure of the digital camera 10 relating to the sixth embodiment is the same as the structure relating to the fifth embodiment (see FIG. 1, FIG. 3 and FIG. 14), so descriptions thereof will not be given here.

In the digital camera 10 relating to the sixth embodiment, when the photography mode is activated, imaging by the CCD 24 commences. Then, at the time of imaging, display control processing is executed to perform processing as follows. In a case in which face characteristic information representing characteristics of a person's face—including orientation information representing an orientation of the person's face—has been extracted from the digital image information obtained by the performance of imaging, a face photography assistance image, for assisting a determination of composition when photographing the person's face, is determined. When general subject characteristic information representing characteristics of the subject other than a person's face has been extracted, a general assistance image other than a face photography assistance image is determined. Then, in a case in which a face photography assistance image and a general assistance image have been determined, the LCD 38 is controlled such that the face photography assistance image is displayed by the LCD 38 with an orientation corresponding to the orientation of the person's face.

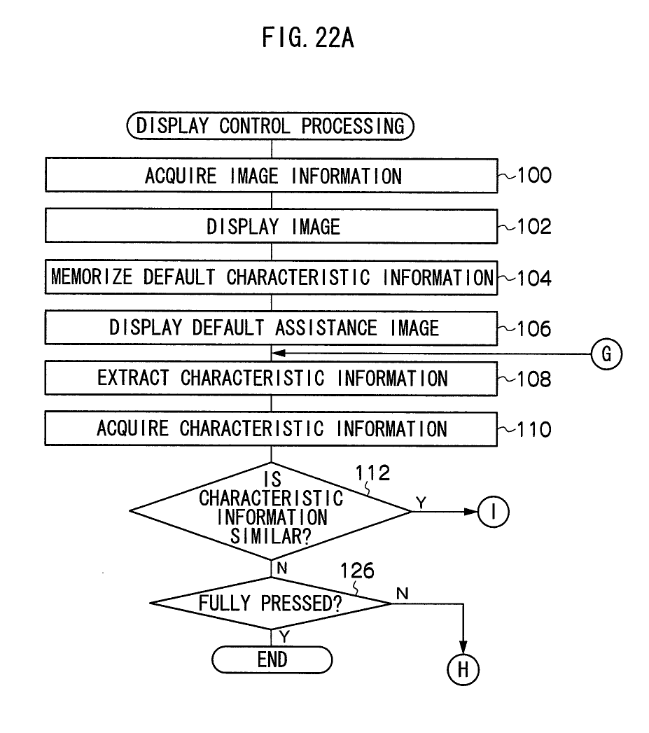

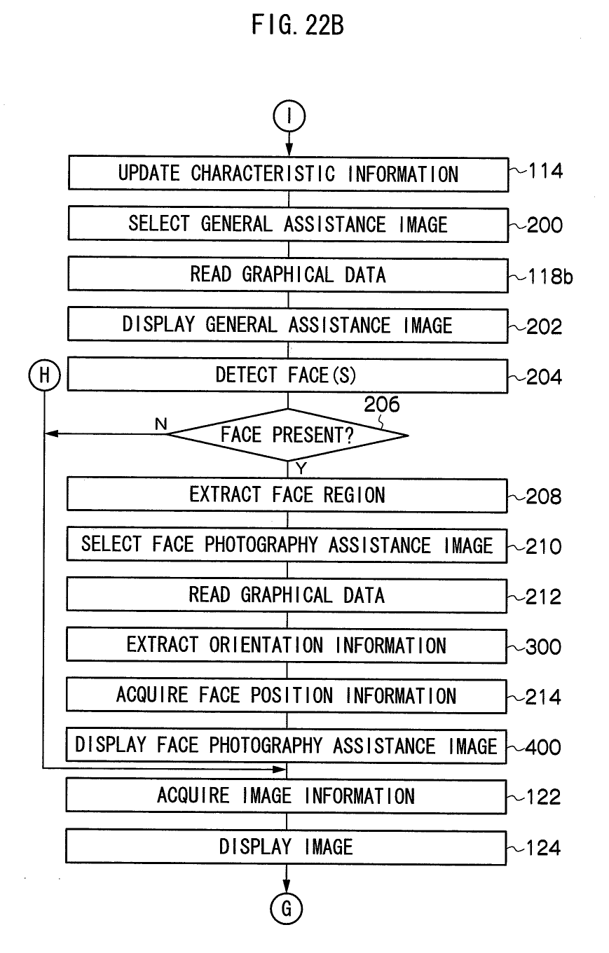

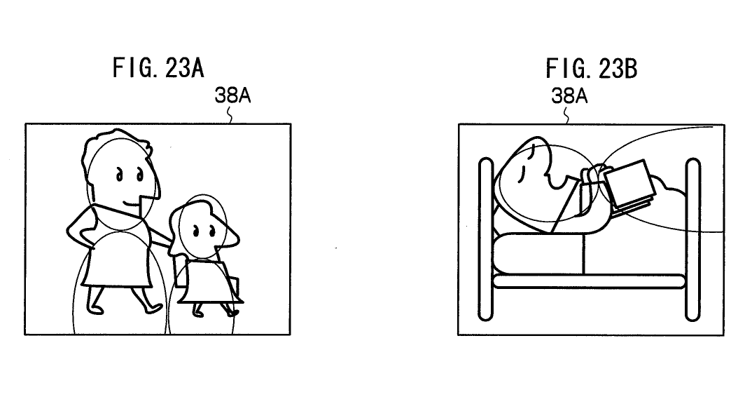

Herebelow, a processing routine of the digital camera 10 when executing the display control processing relating to the sixth embodiment will be described with reference to FIG. 22A and FIG. 22B. FIG. 22A and FIG. 22B are a flowchart illustrating a flow of processing of a display control processing program that is executed by the CPU 40 of the digital camera 10 at such a time. This program is memorized in advance in the ROM region of the memory 48. Steps that perform the same processing in FIG. 22A and FIG. 22B as in FIG. 20A and FIG. 20B are assigned the same reference numerals as in FIG. 20A and FIG. 20B, and descriptions thereof are greatly abbreviated.

Firstly, the processing from step 100 to step 112 described for the fifth embodiment is executed in sequence. If the judgment of step 112 is negative, the routine proceeds to step 114, while if the judgment of step 112 is positive, the routine proceeds to step 126.

In step 114, processing the same as in the fifth embodiment is executed. When the processing of step 114 finishes, the routine proceeds to step 200. From step 200 to step 206, processing the same as in the fifth embodiment is executed in sequence. If the judgment in step 206 is positive, the routine proceeds to step 208, while if the judgment is negative, the routine proceeds to step 122.

From step 208 to step 300, processing the same as in the fifth embodiment is executed in sequence. When the processing of step 300 finishes, the routine proceeds to step 214. In step 214, the same processing as in the fifth embodiment is performed. When the processing of step 214 finishes, the routine proceeds to step 400.

In step 400, processing is performed which displays the face photography assistance image at the LCD 38 in accordance with the face orientation detected in step 300 and the face position information acquired in step 214.

By the processing of step 400, the face photography assistance image is displayed at the screen 38A of the LCD 38 in a state which corresponds to the face orientation detected in step 300, according with the location of the person's face.

For example, in a case in which, as shown in FIG. 23A, a full body image of a person who is standing is photographed in a state in which the digital camera 10 is fixed such that a direction of pressing operation of the release button 56A is along a vertical direction, the face photography assistance image is displayed at the screen 38A of the LCD 38 in a state corresponding to the orientation of the standing person, and accords with the location of the person's face. As a further example, in a case in which, as shown in FIG. 23B, a full body image of a person who is lying down and facing up is photographed in the state in which the digital camera 10 is fixed such that the direction of pressing operation of the release button 56A is along the vertical direction, the face photography assistance image is displayed at the screen 38A of the LCD 38 in a state corresponding to the orientation of the lying down, facing up person, and accords with the location of the person's face.

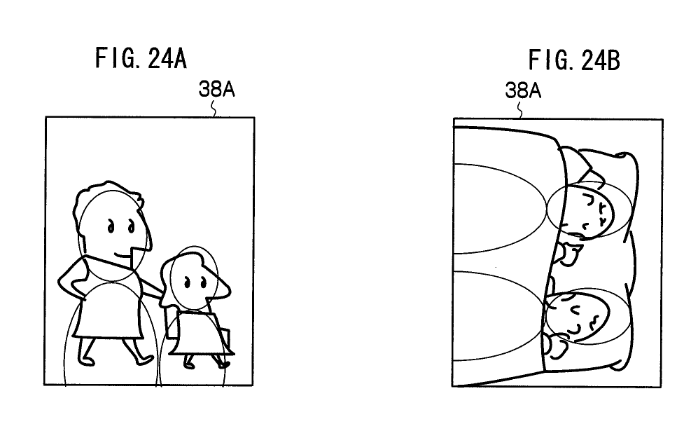

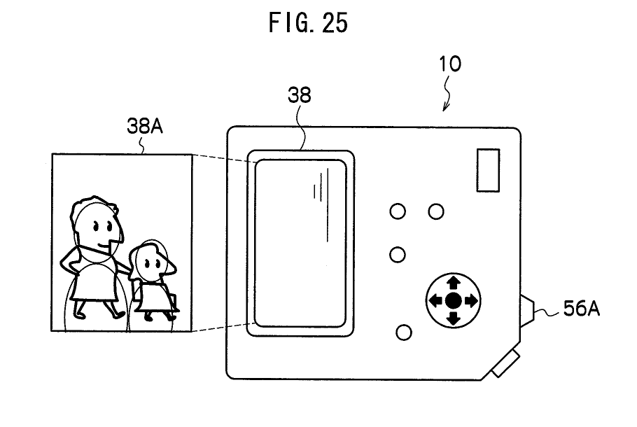

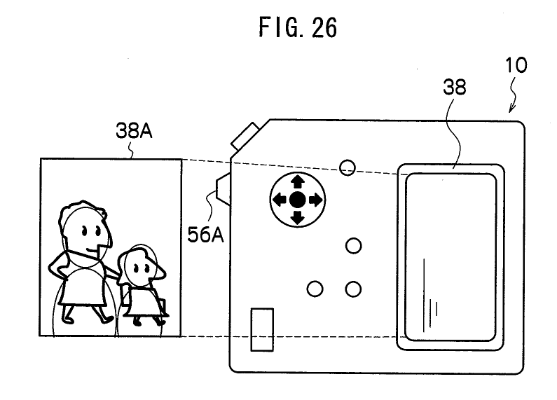

As a contrasting example, in a case in which, as shown in FIG. 24A, a full body image of a person who is standing is photographed in a state in which the digital camera 10 is fixed such that the direction of pressing operation of the release button 56A is along a horizontal direction (see FIG. 25 and FIG. 26), the face photography assistance image is displayed at the screen 38A of the LCD 38 in a state corresponding to the orientation of the standing person, and accords with the location of the person's face. As a yet further example, in a case in which, as shown in FIG. 24B, a full body image of a person who is lying down recumbent along a horizontal direction is photographed in the state in which the digital camera 10 is fixed such that the direction of pressing operation of the release button 56A is along the horizontal direction, the face photography assistance image is displayed at the screen 38A of the LCD 38 in a state corresponding to the orientation of the horizontally recumbent, lying down person, and accords with the location of the person's face.

When the processing of step 400 finishes, the processing from step 122 to step 124 described for the first embodiment is executed in sequence.

Anyway, in step 126, if the judgment thereof is negative, the routine proceeds to step 122, while if this judgment is positive, the present display control processing program ends.

Herein, step 400 of the present display control processing program corresponds to the control component and the step of implementing control of the present invention.

As has been described in detail hereabove, according to the above-described embodiments: image characteristic information representing pre-specified characteristics (here, outlines of a subject) is extracted from image information (here, digital image information) which is acquired by an imaging component; an assistance image, for assisting a determination of composition when photographing the subject, is determined on the basis of the extraction results; and a display component (here, the LCD 38) is controlled such that the assistance image is displayed, superposed with the subject, by the display component. Thus, an assistance image that corresponds to a subject can be displayed with ease.

Furthermore, according to the above-described first embodiment, characteristic information representing the pre-specified characteristics is detected from digital image information obtained by the performance of imaging, an assistance image for assisting a determination of composition when photographing the subject is selected on the basis of the detection results, and the display component is controlled such that the assistance image is displayed superimposed with the subject by the display component. Thus, an assistance image that corresponds to a subject can be displayed with ease.

According to the above-described second embodiment, characteristic information representing the pre-specified characteristics is extracted from digital image information obtained by the performance of imaging, an assistance image for assisting a determination of composition when photographing the subject is created on the basis of the extraction results, and the display component is controlled such that the assistance image is displayed superimposed with the subject by the display component. Thus, an assistance image that corresponds to a subject can be displayed with ease.

According to the above-described third embodiment, characteristic information representing the pre-specified characteristics is extracted from digital image information obtained by the performance of imaging, an assistance image for assisting a determination of composition when photographing the subject is determined on the basis of the extraction results, and the display component is controlled such that the assistance image is partially altered in state on the basis of the extraction results and the assistance image is displayed superimposed with the subject by the display component. Thus, an assistance image that corresponds to a subject can be displayed with ease.

According to the above-described fourth embodiment: face characteristic information (here, face region data) representing characteristics of a person's face and general subject characteristic information representing characteristics of the subject other than the person's face are extracted from digital image information obtained by the performance of imaging; if face characteristic information has been extracted, a face photography assistance image for assisting a determination of composition when photographing the person's face is determined on the basis of the face characteristic information to serve as an assistance image, and if general subject characteristic information has been extracted, a general assistance image, other than the face photography assistance image, is determined on the basis of the general subject characteristic information to serve as an assistance image. Then, if a face photography assistance image and a general assistance image have been determined, the display component is controlled such that the general assistance image is displayed superimposed with the subject and the face photography assistance image is displayed at a location of the person's face that is being displayed. Thus, assistance images that correspond to a subject can be displayed with ease.

According to the above-described fifth embodiment: face characteristic information representing characteristics of a person's face, including orientation information representing an orientation of the person's face, and general subject characteristic information representing characteristics of the subject other than the person's face are extracted from digital image information obtained by the performance of imaging; if face characteristic information has been extracted, a face photography assistance image for assisting a determination of composition when photographing the person's face is determined on the basis of the face characteristic information to serve as an assistance image, and if general subject characteristic information has been extracted, a general assistance image, other than the face photography assistance image, is determined to serve as an assistance image. Then, if a face photography assistance image and a general assistance image have been determined and the orientation of the person's face represented by the orientation information crosses the imaging direction, the display component is controlled such that the general assistance image is displayed superimposed with the subject and the face photography assistance image is displayed at a location at which a space to the side of the orientation of the person's face represented by the orientation information is broader than a space to the other side from the orientation side. Thus, assistance images that correspond to a subject can be displayed with ease.

According to the above-described sixth embodiment: face characteristic information representing characteristics of a person's face, including orientation information representing an orientation of the person's face, and general subject characteristic information representing characteristics of the subject other than the person's face are extracted from digital image information obtained by the performance of imaging; if face characteristic information has been extracted, a face photography assistance image for assisting a determination of composition when photographing the person's face is determined on the basis of the face characteristic information to serve as an assistance image, and if general subject characteristic information has been extracted, a general assistance image, other than the face photography assistance image, is determined to serve as an assistance image. Then, if a face photography assistance image and a general assistance image have been determined, the display component is controlled such that the face photography assistance image is displayed with an orientation corresponding to the orientation of the person's face represented by the orientation information. Thus, assistance images that correspond to a subject can be displayed with ease.

Hereabove, respective embodiments of the present invention have been described, but the technological scope of the present invention is not to be limited to the scope described with the above embodiments. Many modifications and improvements can be applied to the above embodiments within a scope not departing from the spirit of the present invention, and modes in which these modifications/improvements have been applied are to be included in the technological scope of the present invention.

Moreover, the above embodiments do not limit the invention described in the claims, and are not limiting in all of the combinations of characteristics described in the above embodiments being necessary for means for achieving the invention. Inventions with various stages of the above embodiments are to be included, and many inventions can be derived by suitably combining the plural structural requirements that are disclosed. Even if some structural requirement is removed from the totality of structural requirements described for the above embodiments, as long as the effect can be achieved, a structure from which the some structural requirement has been removed can be derived to serve as the invention.

Further still, in the embodiments described above, examples have been described in which the display control processing program is memorized beforehand at the ROM region of the memory 48. However, the present invention is not limited thus. It is also possible to employ a mode in which the display control processing program is provided in a state of being stored at a computer-readable storage medium, a mode in which the display control processing program is distributed through a communication component, by wiring or wirelessly, and so forth.

Further, the structures of the digital camera 10 described for the above embodiments (see FIG. 1, FIG. 2, FIG. 3 and FIG. 14) are examples, and suitable modifications thereof are possible within a scope not departing from the spirit of the present invention.

Further, the flows of processing of the display control processing program described for the above embodiments (FIG. 4, FIG. 8, FIG. 12, FIG. 15A and FIG. 15B, FIG. 20A and FIG. 20B, and FIG. 22A and FIG. 22B) are also examples. Within a scope not departing from the spirit of the present invention, unnecessary steps can be removed, new steps can be added and processing sequences can be rearranged, and suitable modifications are possible. For example, it is possible to use the step 116b shown in FIG. 8 in place of the step 116 and step 118 shown in FIG. 12.

Further, for the first embodiment, an example has been described which uses the assistance image shown in FIG. 6A as a default assistance image. However, the present invention is not limited thus. Any one of the assistance images shown in FIG. 6B to FIG. 6F could serve as the default assistance image, or an assistance image other than the assistance images shown in FIG. 6A to FIG. 6F could serve as the default assistance image.

For the fourth embodiment, an example has been described in which the six assistance images shown in FIG. 6A to FIG. 6F serve as general assistance images. However, the present invention is not limited thus. Assistance images other than the assistance images shown in FIG. 6A to FIG. 6F may serve as general assistance images.

Furthermore, for the fourth embodiment, an example has been described in which an ellipse serves as a face photography assistance image. However, the present invention is not limited thus. Something other than an ellipse, such as an inverted triangle or the like, will be acceptable; any face photography assistance image will be acceptable as long as that assistance image can assist a determination of composition when photographing a person's face.

Further, for the fourth embodiment, an example has been described in which respective weightings are applied to 25 intersections, at which five straight lines which divide the screen 38A of the LCD 38 into equal sixths in the horizontal direction and five straight lines which divide the screen 38A of the LCD 38 into equal sixths in the vertical direction intersect, with the same weighting a being applied to the intersection at the center of the screen 38A and the four intersections at which the two lines that divide the screen 38A of the LCD 38 into equal thirds in the horizontal direction and the two lines that divide the screen 38A of the LCD 38 into equal thirds in the vertical direction intersect, and a weighting β, which is smaller than the weighting a being applied to the other intersections. However, the present invention is not limited thus. Intersections to which the weightings α and β are applied may be suitably altered, and the number of different weighting categories may be set to three or more categories.

Further, for the fourth embodiment, the example has been described in which the respective weightings are applied to the 25 intersections at which the five straight lines which divide the screen 38A of the LCD 38 into equal sixths in the horizontal direction and the five straight lines which divide the screen 38A of the LCD 38 into equal sixths in the vertical direction intersect. However, positions and numbers of points to which weightings are applied may be suitably altered.

For the fifth embodiment, an example has been described in which, when an orientation of a face and an orientation of an imaging direction do not cross, position information of the face is acquired, and the face photography assistance image is displayed to accord with the position of the face. However, the present invention is not limited thus. The face photography assistance image may be displayed at a pre-specified position of the LCD 38.

For the fourth to sixth embodiments, examples have been described in which a general assistance image is selected, and graphical data representing the general assistance image is read out from the memory 48. However, the present invention is not limited thus. It is also possible to generate graphical data for the general assistance image, as has been described for the second embodiment.

Further, for the fourth to sixth embodiments, examples have been described in which a face photography assistance image is selected, and graphical data representing the face photography assistance image is read out from the memory 48. However, the present invention is not limited thus. It is also possible to generate graphical data for the face photography assistance image, as has been described for the second embodiment.

For the sixth embodiment, an example has been described in which a face photography assistance image is displayed in a state in which an orientation thereof corresponds to the orientation of a person's face. However, the present invention is not limited thus. It is also possible for a general assistance image to be displayed in a state in which an orientation thereof corresponds to the orientation of a person's face. Furthermore, it is possible for both a face photography assistance image and a general assistance image to be displayed in a state in which orientations thereof correspond to the orientation of a person's face.

For the embodiments described above, examples have been described in which data representing outlines of a subject serves as characteristic information. However, the present invention is not limited thus. It is also possible to employ data representing hues of a subject, data representing brightnesses of a subject, or the like as the characteristic information. Provided the data represents characteristics of a subject from digital image information acquired by imaging of the subject, and the data can be referred to in determining an assistance image for assisting a determination of composition when photographing the subject, the data will be acceptable.

A digital camera of a first aspect of the present invention includes: an imaging component that images a subject and outputs image information representing the subject; a display component that implements display on the basis of the image information outputted from the imaging component; a characteristic information extraction component that extracts characteristic information representing a pre-specified characteristic from the image information; an assistance image determination component that determines an assistance image, for assisting a determination of composition when photographing the subject, on the basis of a result of extraction by the characteristic information extraction component; and a control component that controls the display component such that the assistance image determined by the assistance image determination component is displayed superimposed with the subject that is being displayed by the display component.

According to the first aspect, a subject is imaged and image information representing the subject is outputted by the imaging component, and display is implemented by the display component on the basis of the image information outputted from the imaging component.

Then, in the present invention, characteristic information representing the pre-specified characteristic is extracted from the image information by the characteristic information extraction component, and an assistance image, for assisting a determination of composition when photographing the subject, is determined by the assistance image determination component on the basis of results of the extraction by the characteristic information extraction component.

In the present invention, the display component is controlled by the control component such that the assistance image that has been determined by the assistance image determination component is displayed superimposed with the subject that is being displayed by the display component.

Thus, according to the present invention, it is possible to display an assistance image that corresponds to a subject with ease, by extracting characteristic information representing the pre-specified characteristic from the image information, determining an assistance image for assisting a determination of composition when photographing the subject on the basis of the extraction results, and controlling the display component such that the assistance image is displayed by the display component superimposed with the subject that is being displayed.

The present invention may further include a judgment component that judges whether or not the characteristic information extracted by the characteristic information extraction component is varied, with the assistance image determination component determining the assistance image on the basis of the characteristic information extracted by the characteristic information extraction component when it has been judged by the judgment component that the characteristic information is varied. Thus, an assistance image that corresponds to the subject can be displayed with ease.

Further, the present invention may further include a memory component at which a plurality of types of mutually different assistance images are memorized in advance, in association with characteristic information, with the assistance image determination component selecting an assistance image that corresponds to the characteristic information extracted by the characteristic information extraction component from the plurality of types of assistance images. Thus, an assistance image that corresponds to the subject can be displayed with ease.

Further, in the present invention, the assistance image determination component may create an assistance image on the basis of the characteristic information extracted by the characteristic information extraction component. Thus, an assistance image that corresponds to the subject can be displayed with ease.

Further, in the present invention, the control component may control the display component such that the assistance image determined by the assistance image determination component is displayed with the assistance image being partially altered in state on the basis of the result of the extraction by the characteristic information extraction component. Thus, an assistance image that corresponds to the subject can be displayed with ease.

Further, in the present invention, the characteristic information extraction component may extract, from the image information, face characteristic information representing a characteristic of a face of a person and general subject characteristic information representing a characteristic of the subject other than the face of the person, with, if the face characteristic information has been extracted by the characteristic information extraction component, the assistance image determination component determining a face photography assistance image, for assisting a determination of composition when photographing the face of the person, on the basis of the face characteristic information to serve as an assistance image, and if the general subject characteristic information has been extracted by the characteristic information extraction component, the assistance image determination component determining a general assistance image, other than the face photography assistance image, on the basis of the general subject characteristic information to serve as an assistance image, and if the face photography assistance image and the general assistance image have been determined by the assistant image determination component, the control component controlling the display component such that the general assistance image determined by the assistance image determination component is displayed superimposed with the subject that is being displayed, and the face photography assistance image determined by the assistance image determination component is displayed at a position of the face of the person that is being displayed. Thus, an assistance image that corresponds to the subject can be displayed with ease.

Further, in the present invention, the face characteristic information may include orientation information representing an orientation of the face of the person, with, if the face photography assistance image and the general assistance image have been determined by the assistance image determination component, the control component controlling the display component such that the face photography assistance image is displayed with an orientation corresponding to the orientation of the face of the person that is represented by the orientation information. Thus, an assistance image that corresponds to the subject can be displayed with ease.

Further, in the present invention, the characteristic information extraction component may extract, from the image information, face characteristic information representing a characteristic of a face of a person, including orientation information representing an orientation of the face of the person, and general subject characteristic information representing a characteristic of the subject other than the face of the person, with, if the face characteristic information has been extracted by the characteristic information extraction component, the assistance image determination component determining a face photography assistance image, for assisting a determination of composition when photographing the face of the person, on the basis of the face characteristic information to serve as an assistance image, and if the general subject characteristic information has been extracted by the characteristic information extraction component, the assistance image determination component determining a general assistance image, other than the face photography assistance image, to serve as an assistance image, and if the face photography assistance image and the general assistance image have been determined by the assistant image determination component and the orientation of the face of the person represented by the orientation information crosses a direction of imaging, the control component controlling the display component such that the general assistance image determined by the assistance image determination component is displayed superimposed with the subject that is being displayed, and the face photography assistance image determined by the assistance image determination component is displayed at a position at which a space at a side of the orientation of the face of the person represented by the orientation information is broader than a space at an opposite side from the orientation side. Thus, an assistance image that corresponds to the subject can be displayed with ease.

Further, in the present invention, if the face photography assistance image and the general assistance image have been determined by the assistance image determination component, the control component may control the display component such that the face photography assistance image is displayed with an orientation corresponding to the orientation of the face of the person that is represented by the orientation information. Thus, an assistance image that corresponds to the subject can be displayed with ease.

Further, in the present invention, the face characteristic information may include size information representing a size of the face of the person, with, if the face characteristic information has been extracted by the face characteristic information extraction component, the assistance image determination component determining a face photography assistance image corresponding to the size of the face of the person represented by the size information to serve as the assistance image. Thus, an assistance image that corresponds to the subject can be displayed with ease.

A digital camera control process of a second aspect of the present invention includes: an imaging step of imaging a subject and outputting image information representing the subject; a display step of implementing display on the basis of the image information; a characteristic information extraction step of extracting characteristic information representing a pre-specified characteristic from the image information; an assistance image determination step of determining an assistance image, for assisting a determination of composition when photographing the subject, on the basis of a result of the extraction in the characteristic information extraction step; and a control step of implementing control such that the assistance image determined by the assistance image determination step is displayed superimposed with the subject displayed by the display step.

A control program stored at a storage medium of a third aspect of the present invention includes: an imaging step of outputting image information representing a subject which has been imaged; a step of controlling a display component so as to implement display on the basis of the image information; a characteristic information extraction step of extracting characteristic information representing a pre-specified characteristic from the image information; an assistance image determination step of determining an assistance image, for assisting a determination of composition when photographing the subject, on the basis of a result of the extraction in the characteristic information extraction step; and a control step of implementing control such that the assistance image determined by the assistance image determination step is displayed superimposed with the subject that is being displayed at the display component.

Thus, according to the third aspect, it is possible to cause a computer to operate in a similar manner to the first aspect. Therefore, similarly to the first aspect, it is possible to display an assistance image that corresponds to a subject with ease.

According to a digital camera, digital camera control process and storage medium storing a control program relating to the present invention, an excellent effect can be provided in that it is possible to cause an assistance image corresponding to a subject to be displayed with ease.

What is claimed is:

1. A digital camera comprising:
an imaging component that images a subject and outputs image information representing the subject;
a display component that implements display on the basis of the image information outputted from the imaging component;
a characteristic information extraction component that extracts characteristic information representing a pre-specified characteristic from the image information;
an assistance image determination component that determines an assistance image, for assisting a determination of composition when the subject is to be photographed, on the basis of a result of extraction by the characteristic information extraction component; and
a control component that controls the display component such that the assistance image determined by the assistance image determination component is displayed superimposed with the subject that is being displayed by the display component.

2. The digital camera of claim 1, further comprising a judgment component that judges whether or not the characteristic information extracted by the characteristic information extraction component is varied,
wherein the assistance image determination component determines the assistance image on the basis of the characteristic information extracted by the characteristic information extraction component when it has been judged by the judgment component that the characteristic information is varied.

3. The digital camera of claim 1, further comprising a memory component at which a plurality of types of mutually different assistance images are memorized in advance, in association with characteristic information,
wherein the assistance image determination component selects an assistance image that corresponds to the characteristic information extracted by the characteristic information extraction component from the plurality of types of assistance images.

4. The digital camera of claim 1, wherein the assistance image determination component creates an assistance image on the basis of the characteristic information extracted by the characteristic information extraction component.

5. The digital camera of claim 1, wherein the control component controls the display component such that the assistance image determined by the assistance image determination component is displayed with the assistance image being partially altered in state on the basis of the result of the extraction by the characteristic information extraction component.

6. The digital camera of claim 1, wherein
the characteristic information extraction component extracts, from the image information, face characteristic information representing a characteristic of a face of a person and general subject characteristic information representing a characteristic of the subject other than the face of the person,
when the face characteristic information has been extracted by the characteristic information extraction component, the assistance image determination component determines a face photography assistance image, for assisting a determination of composition when the face of the person is to be photographed, on the basis of the face characteristic information to serve as an assistance image, and when the general subject characteristic information has been extracted by the characteristic information extraction component, the assistance image determination component determines a general assistance image, other than the face photography assistance image, on the basis of the general subject characteristic information to serve as an assistance image, and
when the face photography assistance image and the general assistance image have been determined by the assistant image determination component, the control component controls the display component such that the general assistance image determined by the assistance image determination component is displayed superimposed with the subject that is being displayed, and the face photography assistance image determined by the assistance image determination component is displayed at a position of the face of the person that is being displayed.

7. The digital camera of claim 6, wherein
the face characteristic information includes orientation information representing an orientation of the face of the person, and
when the face photography assistance image and the general assistance image have been determined by the assistance image determination component, the control component controls the display component such that the face photography assistance image is displayed with an orientation corresponding to the orientation of the face of the person that is represented by the orientation information.

8. The digital camera of claim 6, wherein
the face characteristic information includes size information representing a size of the face of the person, and
when the face characteristic information has been extracted by the face characteristic information extraction component, the assistance image determination component determines a face photography assistance image corresponding to the size of the face of the person represented by the size information to serve as the assistance image.

9. The digital camera of claim 1, wherein
the characteristic information extraction component extracts, from the image information, face characteristic information representing a characteristic of a face of a person, including orientation information representing an orientation of the face of the person, and general subject characteristic information representing a characteristic of the subject other than the face of the person,
when the face characteristic information has been extracted by the characteristic information extraction component, the assistance image determination component determines a face photography assistance image, for assisting a determination of composition when the face of the person is to be photographed, on the basis of the face characteristic information to serve as an assistance image, and when the general subject characteristic information has been extracted by the characteristic information extraction component, the assistance image determination component determines a general assistance image, other than the face photography assistance image, to serve as an assistance image, and
when the face photography assistance image and the general assistance image have been determined by the assistant image determination component and the orientation of the face of the person represented by the orientation information crosses a direction of imaging, the control component controls the display component such that the general assistance image determined by the assistance image determination component is displayed superimposed with the subject that is being displayed, and the face photography assistance image determined by the assistance image determination component is displayed at a position at which a space at a side of the orientation of the face of the person represented by the orientation information is broader than a space at an opposite side from the orientation side.

10. The digital camera of claim 9 wherein, when the face photography assistance image and the general assistance image have been determined by the assistance image determination component, the control component controls the display component such that the face photography assistance image is displayed with an orientation corresponding to the orientation of the face of the person that is represented by the orientation information.

11. A digital camera control method comprising:
(a) imaging a subject and outputting image information representing the subject;
(b) implementing display on the basis of the image information;
(c) extracting characteristic information representing a pre-specified characteristic from the image information;
(d) determining an assistance image, for assisting a determination of composition when the subject is to be photographed, on the basis of a result of the extraction in (c); and
(e) implementing control such that the assistance image determined by (d) is displayed superimposed with the subject displayed by (b).

12. A storage medium readable by a computer, the storage medium storing a program of instructions executable by the computer to perform a function, the function comprising:
(a) outputting image information representing a subject which has been imaged;
(b) controlling a display component so as to implement display on the basis of the image information;
(c) extracting characteristic information representing a pre-specified characteristic from the image information;
(d) determining an assistance image, for assisting a determination of composition when the subject is to be photographed, on the basis of a result of the extraction in (c); and
(e) implementing control such that the assistance image determined by (d) is displayed superimposed with the subject that is being displayed at the display component.
